(19) United States
(12) Patent Application Publication
(10) Pub. No.: US 2025/0331005 A1
(43) Pub. Date: Oct. 23, 2025

(54) ENHANCED SOFT RESOURCE MANAGEMENT IN INTEGRATED ACCESS AND BACKHAUL

(71) Applicant: Lenovo (Singapore) Pte. Ltd., New Tech Park (SG)

(72) Inventors: Majid Ghanbarinejad, Chicago, IL (US); Hyejung Jung, Northbrook, IL (US); Vijay Nangia, Woodridge, IL (US)

(21) Appl. No.: 18/261,814

(22) PCT Filed: Jan. 17, 2022
(86) PCT No.: PCT/IB2022/050361

§ 371 Date: Jul. 17, 2023

Related U.S. Application Data
(60) Provisional application No. 63/138,352, filed on Jan. 15, 2021.

(51) Int. Cl. H04W 72/27; H04W 72/044

(52) U.S. Cl. CPC H04W 72/27; H04W 72/044

(57) ABSTRACT

Various aspects of the present disclosure relate to soft resource management in integrated access and backhaul may be used. An apparatus includes a transceiver that receives configurations for a plurality of resource block groups, the configurations comprising an indication that the plurality of resource block groups is soft and an availability combination associated with the plurality of resource block groups and receives an availability indication control message associated with the availability combination, the availability indication control message comprising an availability indication field associated with the plurality of resource block groups. The apparatus includes a processor that determines that physical resource blocks in the plurality of resource block groups in a plurality of physical resource block groups are available in response to the availability indication field being equal to ‘1’ and unavailable in response to the availability indication field being equal to ‘0’.

### CROSS-REFERENCE TO RELATED APPLICATIONS

This application claims priority to U.S. Provisional Patent Application No. 63/138,352 entitled “APPARATUSES, METHODS, AND SYSTEMS FOR ENHANCED SOFT RESOURCE MANAGEMENT IN INTEGRATED ACCESS AND BACKHAUL” and filed on Jan. 15, 2021, for Majid Ghanbarinejad, et al., which is incorporated herein by reference.

### FIELD

The subject matter disclosed herein relates generally to wireless communications and more particularly relates to enhanced soft resource management in integrated access and backhaul.

### BACKGROUND

In certain wireless communication systems, a User Equipment device (“UE”) is able to connect with a fifth-generation (“5G”) core network (e.g., “5GC”) in a Public Land Mobile Network (“PLMN”). In certain wireless communications networks, soft resources in integrated access and backhaul systems may be used.

### BRIEF SUMMARY

Disclosed are procedures for soft resource management in integrated access and backhaul may be used. Said procedures may be implemented by apparatus, systems, methods, and/or computer program products.

In one embodiment, a first apparatus includes a transceiver that receives configurations for a plurality of resource block groups, the configurations comprising an indication that the plurality of resource block groups is soft and an availability combination associated with the plurality of resource block groups. In one embodiment, the transceiver receives an availability indication control message associated with the availability combination, the availability indication control message comprising an availability indication field associated with the plurality of resource block groups. In one embodiment, the first apparatus includes a processor that determines that physical resource blocks in the plurality of resource block groups in a plurality of physical resource block groups are available in response to the availability indication field being equal to ‘1’ and unavailable in response to the availability indication field being equal to ‘0’.

In one embodiment, a first method includes receiving configurations for a plurality of resource block groups, the configurations comprising an indication that the plurality of resource block groups is soft and an availability combination associated with the plurality of resource block groups. In one embodiment, the first method includes receiving an availability indication control message associated with the availability combination, the availability indication control message comprising an availability indication field associated with the plurality of resource block groups. In one embodiment, the first method includes determining that physical resource blocks in the plurality of resource block groups in a plurality of physical resource block groups are available in response to the availability indication field being equal to ‘1’ and unavailable in response to the availability indication field being equal to ‘0’.

In one embodiment, a second apparatus includes a processor that determines an availability of physical resource blocks in a plurality of resource block groups in a plurality of physical resource block groups. In one embodiment, the second apparatus includes a transceiver that transmits configurations for a plurality of resource block groups to second network nodes, the configurations comprising an indication that the plurality of resource block groups is soft and an availability combination associated with the plurality of resource block groups and transmits an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

In one embodiment, a second method includes determining an availability of physical resource blocks in a plurality of resource block groups in a plurality of physical resource block groups. In one embodiment, the second method includes transmitting configurations for a plurality of resource block groups to second network nodes, the configurations comprising an indication that the plurality of resource block groups is soft and an availability combination associated with the plurality of resource block groups and transmitting an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for soft resource management in integrated access and backhaul;

FIG. 2A depicts an example of an integrated access and backhaul (IAB) system (in standalone mode);

FIG. 2B depicts the CU/DU split in an IAB donor and the DU/MT split in IAB nodes;

FIG. 3 shows the information element AvailabiltyCombinationsPerCell that is used to configure the AvailabiltyCombinations applicable for a serving cell of the IAB-node DU;

FIG. 4, shows the IE AvailabilityIndicator that is used to configure monitoring a PDCCH for Availability Indicators;

FIG. 5 shows an IE that contains the resource configuration of the cells served by a gNB-DU;

FIG. 6 depicts an example of an IAB system with single-panel and multi-panel IAB nodes;

FIG. 7 depicts scenarios of simultaneous transmission and/or reception operations;

FIG. 8 depicts joint vs. separate time-frequency configuration/signaling;

FIG. 9 provides an example ASN.1 code for a configuration of resources may assign an attribute such as a D/U/F or an H/S/NA attribute to one or a plurality of RBGs;

FIG. 10 depicts an IAB node connected to a parent node and a child node;

FIG. 11 depicts a parent node controlling resources in upstream and downstream links of an IAB node;

FIG. 12 depicts an example of variable inter-cell interference from an IAB system to a legacy cell;

FIG. 13 depicts an example timeline and associations between reference signals and a flexible and/or soft resource;

FIG. 14 is a block diagram illustrating one embodiment of a user equipment apparatus that may be used for soft resource management in integrated access and backhaul;

FIG. 15 is a block diagram illustrating one embodiment of a network apparatus that may be used for soft resource management in integrated access and backhaul;

FIG. 16 is a flowchart diagram illustrating one embodiment of a method for soft resource management in integrated access and backhaul; and

FIG. 17 is a flowchart diagram illustrating one embodiment of a method for soft resource management in integrated access and backhaul.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for soft resource management in integrated access and backhaul may be used. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Integrated access and backhaul (“IAB”) was specified for new radio access technology (“NR”) Release 16 (“Rel-16”). The IAB technology aims at increasing deployment flexibility and reducing 5G rollout costs. It allows service providers to reduce cell planning and spectrum planning efforts while utilizing the wireless backhaul technology.

Although the IAB specification in Rel-16 is not limited to a specific multiplexing and duplexing scheme, the focus is on time-division multiplexing (“TDM”) between upstream communications (with a parent IAB node or IAB donor) and downstream communications (with a child IAB node or a UE).

It was approved for the 3GPP Rel-17 to enhance resource multiplexing for supporting simultaneous operations (transmissions and/or receptions) in downstream and upstream by an IAB node, as listed in the following objectives [RP-201293]:

### Duplexing Enhancements:

i. Specification of enhancements to the resource multiplexing between child and parent links of an IAB node, including:
   1. Support of simultaneous operation (transmission and/or reception) of IAB-node's child and parent links (e.g., MT Tx/DU Tx, MT Tx/DU Rx, MT Rx/DU Tx, MT Rx/DU Rx).
   2. Support for dual-connectivity scenarios defined by RAN2/RAN3 in the context of topology redundancy for improved robustness and load balancing.
ii. Specification of IAB-node timing mode(s), extensions for DL/UL power control, and CLI and interference measurements of BH links, as needed, to support simultaneous operation (transmission and/or reception) by IAB-node's child and parent links.

As highlighted in the above objectives, the main IAB enhancements pursued in Rel-17 are enhancements to resource multiplexing between upstream and downstream communications. Solutions based on semi-static configurations for enabling simultaneous operations in upstream and downstream links in enhanced IAB nodes have been proposed. These solutions have drawbacks. For example, their response to changes in the system such as the topology, interference, and traffic is slow. Furthermore, these solutions rely on an enhanced IAB donor, while an IAB system with enhanced IAB nodes that are connected to a legacy IAB donor may not enjoy a significant performance advantage.

The concept of soft resources and availability indication (“AI”), which was introduced in IAB Rel-16 for the time domain, suffers from shortcomings for enhanced resource multiplexing. Particularly, according to the current specification, a higher priority is always given to signaling from the parent node for controlling resources of the child node, which is not sufficiently flexible in practical systems where the multiplexing capabilities of IAB nodes may change unpredictably in the presence of beam and power variations, interference, and so on.

The current specification (Rel-16) allows an IAB node to use soft resources at downstream only if it does not conflict with a communication at upstream as configured or scheduled by the parent node or as indicated available by the parent node. In both cases, the parent node determines what resources are available to the IAB node, while there is a risk that the possibility of multiplexing between upstream and downstream changes momentarily at the IAB node without a timely realization by the parent node. It was proposed by a company to allow an IAB node to indicate dynamically whether it is capable of performing enhanced multiplexing, but that may also suffer from slow response.

This disclosure, in one embodiment, addresses the issue of resource multiplexing in several scenarios including scenarios where one of the upstream and downstream links is configured semi-statically whilst the other link is controlled by local dynamic signaling and opportunistic use of resources that are not configured by the IAB donor. Specifically, in the present disclosure, methods are proposed to manage soft resources by control signaling among IAB nodes.

Methods proposed in this disclosure introduce conditional availability indication (CAI), whereby the parent node may indicate to the child node that soft resources at downstream are available provided that certain conditions in relation with upstream resources, directions of communication (DL/UL), beam and power constraints, etc. are satisfied. Furthermore, RAN3 methods proposed in a recent disclosure for inter-donor/gNB TDD resource coordination are extended in relation to the proposed methods. Yet furthermore, more details are provided for frequency-domain soft resource configuration and signaling.

In some embodiments, soft resources are conditionally indicated available (“C-IA”), hence signaling to the IAB node that the resources are available for a downstream communication provided that conditions are met in relation with upstream communications and beam/power/timing constraints. Particularly, a downstream resource conflicting with an upstream communication may or may not be available depending on whether the two communications can be multiplexed, given node capabilities and beam/power/timing conditions. Further signaling from the IAB node may inform the parent node what ratio of C-AI resources were utilized by the IAB node and, furthermore, may be used for inter-donor/gNB signaling for enhanced TDD resource coordination.

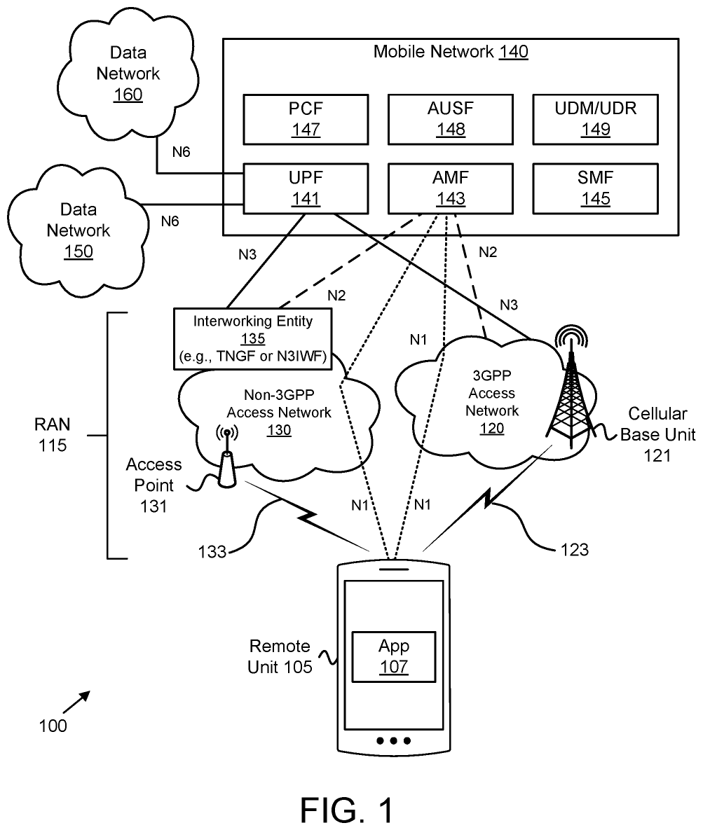

FIG. 1 depicts a wireless communication system 100 for soft resource management in integrated access and backhaul may be used, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-FiR or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (e.g., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific Qos Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, e.g., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (e.g., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (e.g., session establishment, modification, release), remote unit (e.g., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

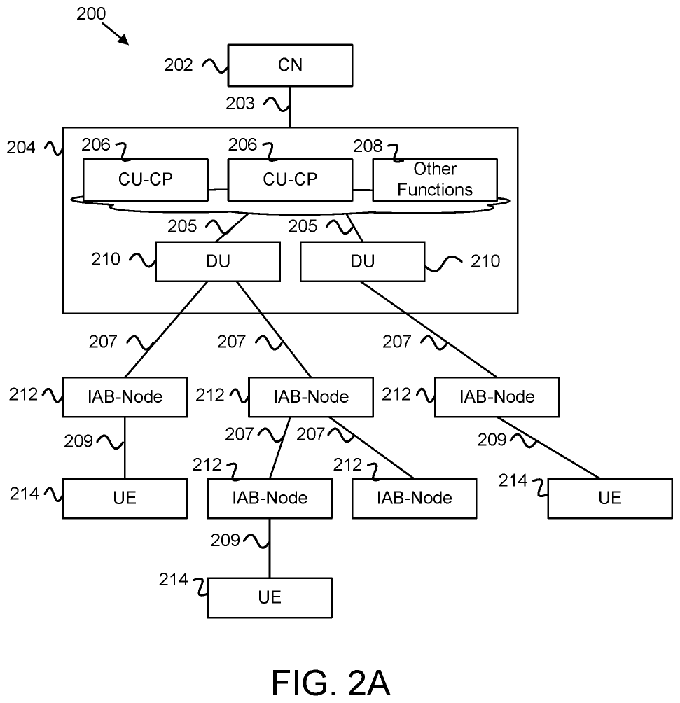

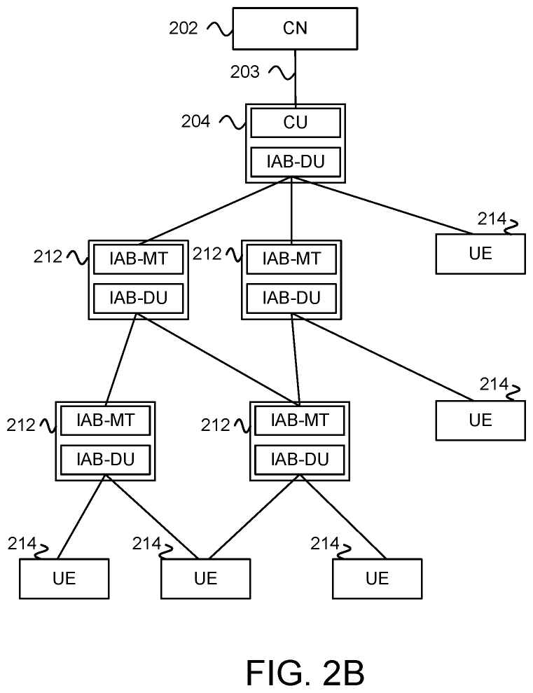

As background, FIG. 2A is an example of an integrated access and backhaul (“IAB”) system 200 (in standalone mode). The core network 202 is connected to an IAB donor 204 of an IAB system 200 through a backhaul link 203, which is typically wired. The IAB donor 204 comprises a central unit (“CU”) 206 that communicates with all the distributed units (“DUs”) 210 in the system through an F1 interface 205. The IAB donor 204 is a single logical node that may comprise a set of functions 208 such as gNB-DU, gNB-CU-CP, gNB-CU-UP, and so on. In a deployment, the IAB donor 204 can be split according to these functions, which can all be either collocated or non-collocated.

Each IAB node 212 is functionally split into at least a distributed unit (“DU”) and a mobile terminal (“MT”). An MT of an IAB node 212 is connected to a DU 210 of a parent node, which may be another IAB node 212 or an IAB donor 204.

A Uu link between an MT of an IAB node 212 (called an IAB-MT) and a DU 210 of a parent node (called an IAB-DU) is called a wireless backhaul link 207. In the wireless backhaul link 207, in terms of functionalities, the MT is similar to user equipment (“UE”) 214 and the DU 210 of the parent node is similar to a base station in a conventional cellular wireless access link. Therefore, a link from an MT to a serving cell that is a DU 210 of a parent link is called an uplink, and a link in the reverse direction is called a downlink. For the sake of brevity, in the rest of this disclosure, embodiments may simply refer to an uplink or a downlink between IAB nodes 212, an upstream link or a downstream link of an IAB node 212, a link between a node and its parent node, a link between a node and its child node, and so on without a direct reference to an IAB-MT, IAB-DU, serving cell, and so on.

Each IAB donor 204 or IAB node 212 may serve UEs 214 through access links 209. IAB systems 200 are designed to allow multi-hop communications, e.g., a UE 214 may be connected to the core network 202 through an access link 209 and multiple backhaul links 207 between IAB nodes 212 and an IAB donor 204. For the rest of this disclosure, unless stated otherwise, an “IAB node” may generally refer to an IAB node 212 or an IAB donor 204 as long as a connection between a CU 206 and a core network 202 is not concerned.

FIG. 2B is a block diagram illustrating one embodiment of a summary of a CU/DU split in an IAB donor 204 and a DU/MT split in IAB nodes 212. FIG. 2B illustrates the functional splits of an IAB donor 204 and IAB nodes 212. In this figure, an IAB node 212 or a UE 214 can be served by more than one serving cell as they support dual connectivity (“DC”).

A node, link, or the like, closer to the IAB donor 204 and/or the core network 202 is called an upstream node or link. For example, a parent node of a subject node is an upstream node of the subject node and the link to the parent node is an upstream link with respect to the subject node. Similarly, a node or link farther from the IAB donor 204 and/or the core network 202 is called a downstream node or link. For example, a child node of a subject node is a downstream node of the subject node and the link to the child node is a downstream link with respect to the subject node.

The following table summarizes the terminology used in this disclosure for the sake of brevity versus the description that may appear in the standard specifications.

TABLE 1

| Phrase | Description |
|---|---|
| Wireless backhaul link | A connection between an MT of an IAB node and a DU of a |
| | serving cell |
| Wireless access link | A connection between a UE and (a DU of) a serving cell |
| IAB-node | RAN node that supports NR access links to UEs and NR |
| | backhaul links to parent nodes and child nodes |
| IAB-MT | IAB-node function that terminates the Uu interface to the |
| | parent node |
| IAB-DU | gNB-DU functionality supported by the IAB-node to |
| | terminate the NR access interface to UEs and next-hop IAB- |
| | nodes, and to terminate the F1 protocol to the gNB-CU |
| | functionality on the IAB-donor |
| IAB-donor | gNB that provides network access to UEs via a network of |
| | backhaul and access links |
| Parent [IAB] node | An IAB node or IAB donor that comprises a serving cell of |
| | the subject node. In some examples, IAB-node-MT's next |
| | hop neighbour node; the parent node can be an IAB-node or |
| | an IAB-donor-DU. |
| Child [IAB] node | An IAB node that identifies the subject node as a serving cell. |
| | In some examples, IAB-node-DU's next hop neighbour node; |
| | the child node is also an IAB-node. |
| Sibling [IAB] node | An IAB node that has a common parent with the subject node |
| Uplink (of a wireless backhaul | A link from an MT to a DU of a parent node |
| link) | |
| Downlink (of a wireless | A link from a DU to an MT of a child node |
| backhaul link) | |
| Upstream node/link/etc. | A node/link/etc. (topologically) closer to the IAB donor / core |
| | network. Direction toward parent node in IAB-topology |
| Downstream node/link/etc. | A node/link/etc. (topologically) farther from the IAB donor / |
| | core network. Direction toward child node or UE in IAB- |
| | topology |

Furthermore, an “operation” or a “communication,” where appropriate, may refer to a transmission or a reception in an uplink (or upstream) or a downlink (or downstream). Then, the terms “simultaneous operation” or “simultaneous communications” may refer to multiplexing/duplexing transmissions and/or receptions by a node through one or multiple antennas/panels. Details of the simultaneous operation should be understood from the context.

Regarding soft resource configurations in IAB Rel. 16 (e.g., from TS 38.213), with reference to slots of an IAB-DU serving cell, a symbol in a slot of an IAB-DU serving cell can be configured to be of hard, soft, or unavailable type. When a downlink, uplink, or flexible symbol is configured as hard, the IAB-DU serving cell can respectively transmit, receive, or either transmit or receive in the symbol.

When a downlink, uplink, or flexible symbol is configured as soft, the IAB-DU can respectively transmit, receive or either transmit or receive in the symbol only if”
i. the IAB-MT does not transmit or receive in the symbol, or
ii. the IAB-MT would transmit or receive in the symbol, and the transmission or reception in the symbol is not changed due to a use of the symbol by the IAB-DU, or
iii. the IAB-MT detects a downlink channel information (“DCI”) format 2_5 with an AI index field value indicating the soft symbol as available

When a symbol is configured as unavailable, the IAB-DU neither transmits nor receives in the symbol.

A symbol of a slot is equivalent to being configured as hard if an IAB-DU would transmit a SS/PBCH block, PDCCH for Type0-PDCCH CSS sets configured by pdcchConfigSIB1, or a periodic CSI-RS in the symbol of the slot or would receive a PRACH or a SR in the symbol of the slot.

If an IAB-node is provided an AvailabilityIndicator, the IAB-node is provided an AI-RNTI by ai-RNTI and a payload size of a DCI format 2_5 by dci-PayloadSize-AI. The IAB-node is also provided a search space set configuration, by SearchSpace, for monitoring PDCCH.

For each serving cell of an IAB-DU in a set of serving cells of the IAB-DU, the IAB-DU can be provided:
i. an identity of the IAB-DU serving cell by iabDuCellId-AI
ii. a location of an availability indicator (AI) index field in DCI format 2_5 by positionInDCI-AI
iii. a set of availability combinations by availabilityCombinations, where each availability combination in the set of availability combinations includes
iv. resourceAvailability indicating availability of soft symbols in one or more slots for the IAB-DU serving cell, and
v. a mapping for the soft symbol availability combinations provided by resourceAvailability to a corresponding AI index field value in DCI format 2_5 provided by availabilityCombinationId

The IAB-DU can assume a same SCS configuration for availabilityCombinations for a serving cell as an SCS configuration provided by IAB-DU-Resource-Configuration-TDD-Config for the serving cell.

An AI index field value in a DCI format 2_5 indicates to an IAB-DU a soft symbol availability in each slot for a number of slots starting from the earliest slot of the IAB-DU which overlaps in time with the slot of the IAB-MT where the IAB-MT detects the DCI format 2_5. The number of slots is equal to or larger than a PDCCH monitoring periodicity for DCI format 2_5 as provided by SearchSpace. The AI index field includes max {┌log₂(maxAIindex+1)┐, 1} bits where maxAIindex is the maximum of the values provided by corresponding availabilityCombinationId. An availability for a soft symbol in a slot is identified by a corresponding value resourceAvailability as provided in Table 2.

TABLE 2
Mapping between values of resourceAvailability elements
and types of soft symbol availability in a slot

| Value | Indication |
|---|---|
| 0 | No indication of availability for soft symbols |
| 1 | DL soft symbols are indicated available |
| | No indication of availability for UL and Flexible soft symbols |
| 2 | UL soft symbols are indicated available |
| | No indication of availability for DL and Flexible soft symbols |
| 3 | DL and UL soft symbols are indicated available |
| | No indication of availability for Flexible soft symbols |
| 4 | Flexible soft symbols are indicated available |
| | No indication of availability for DL and UL soft symbols |
| 5 | DL and Flexible soft symbols are indicated available |
| | No indication of availability for UL soft symbols |
| 6 | UL and Flexible soft symbols are indicated available |
| | No indication of availability for DL soft symbols |
| 7 | DL, UL, and Flexible soft symbols are indicated available |

If a PDCCH monitoring periodicity for DCI format 2_5 is smaller than a duration of an availability combination of soft symbols over a number of slots that the IAB-MT obtains at a PDCCH monitoring occasion for DCI format 2_5 by a corresponding AI index field value, and the IAB-MT detects more than one DCI formats 2_5 indicating an availability combination of soft symbols in a slot, the IAB-MT expects that each of the more than one DCI formats 2_5 indicates a same value for the availability combination of the soft symbols in the slot.

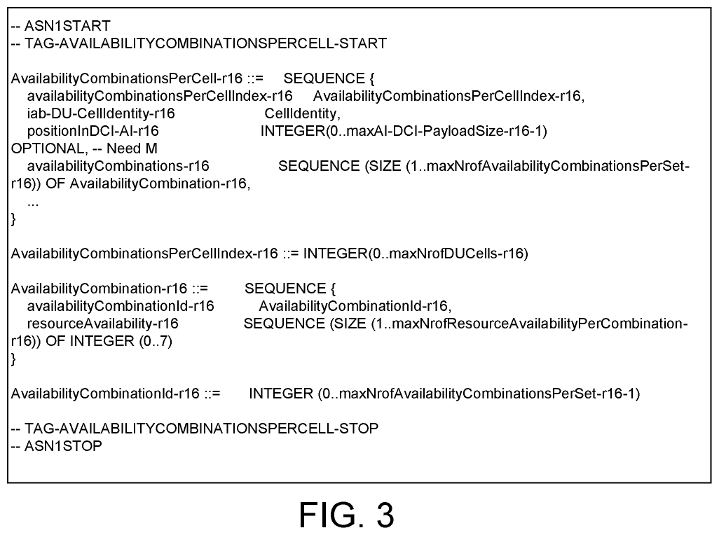

Regarding soft resource configurations in IAB Rel. 16-RAN2, (e.g., according to TS 38.331), FIG. 3 shows the information element (“IE”) AvailabiltyCombinationsPerCell that is used to configure the AvailabiltyCombinations applicable for a serving cell of the IAB-node DU (see TS 38.213).

AvailabilityCombination field descriptions

resourceAvailability
Indicates the resource availability of soft symbols for a set of consecutive
slots in the time domain. The meaning of this field is described in
TS 38.213, Table 14.3.
availabiltyCombinationId
This ID is used in the DCI Format 2_5 payload to dynamically select this
AvailabilityCombination, see TS 38.213, clause 14.

AvailabilityCombinationsPerCell field descriptions

iab-DU-CellIdentity
The ID of the IAB-DU cell for which the availabilityCombinations
are applicable.
positionInDC-AI
The (starting) position (bit) of the AvailabilityCombinationId for the
indicated IAB-DU cell (iab-DU-CellIdentity) within the DCI payload.

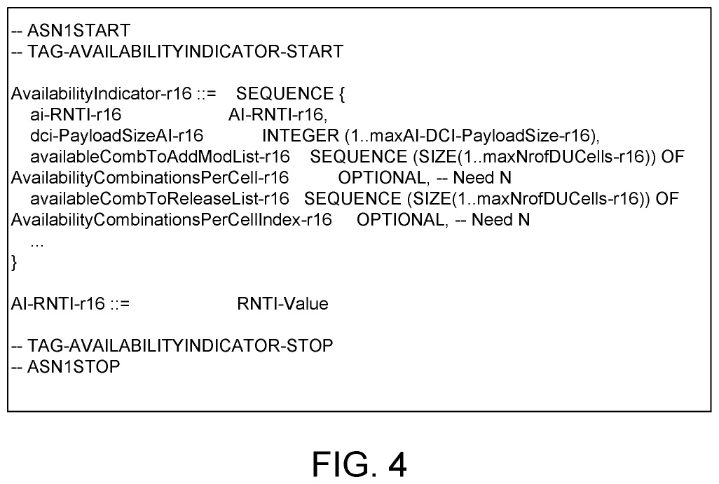

FIG. 4 shows the IE AvailabilityIndicator that is used to configure monitoring a PDCCH for Availability Indicators (“AI”).

AvailabilityIndicator field descriptions

ai-RNTI
Used by an IAB-MT for detection of DCI format 2_5 indicating
AvailabilityCombinationId for an IAB-DU's cells.
availableCombToAddModList
A list of availabilityCombinations to add for the IAB-DU's cells. (see
TS 38.213, clause 14).
availableCombToReleaseList
A list of availabilityCombinations to release for the IAB-DU's cells.
(see TS 38.213, clause 14).
dci-PayloadSizeAI
Total length of the DCI payload scrambled with ai-RNTI (see TS 38.213).

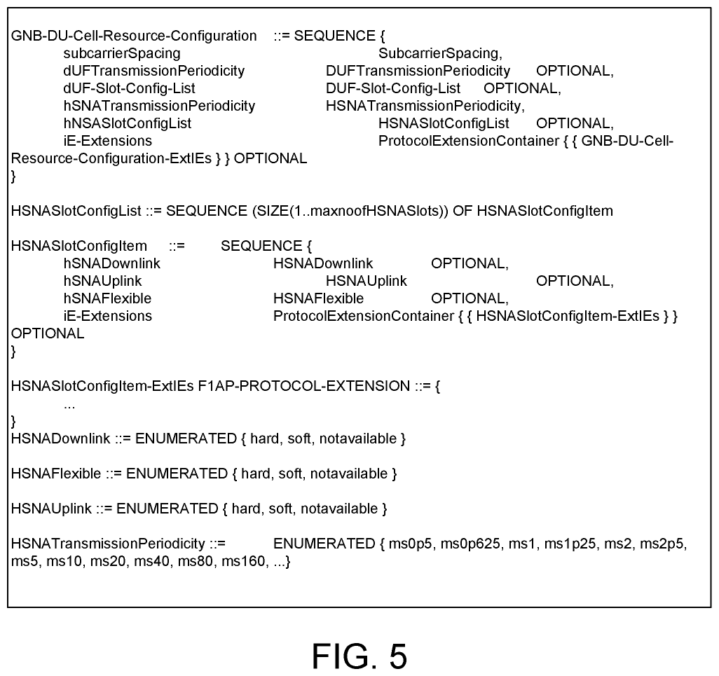

Regarding soft resource configurations in IAB Rel-16-RAN3 (e.g., according to TS 38.473), for gNB-DU Cell Resource Configuration, the IE shown in FIG. 5 contains the resource configuration of the cells served by a gNB-DU, e.g., the TDD/FDD resource parameters for each activated cell (TS 38.213 [31], clause 11.1.1).

| | | | IE type and | Semantics | | Assigned |
|---|---|---|---|---|---|---|
| IE/Group Name | Presence | Range | reference | description | Criticality | Criticality |
| Subcarrier Spacing | M | | ENUMERATED | Subcarrier | YES | reject |
| | | | (kHz 15, kHz 30, | spacing used | | |
| | | | kHz 60, kHz 120, | as reference | | |
| | | | kHz 240, spare3, | for the | | |
| | | | spare2, spare1, | TDD/FDD slot | | |
| | | | . . . ) | configuration. | | |
| DUF Transmission | O | | ENUMERATED | | YES | reject |
| Periodicity | | | (ms0p5, ms0p625, | | | |
| | | | ms1, ms1p25, | | | |
| | | | ms2, ms2p5, ms5, | | | |
| | | | ms10, . . . ) | | | |
| DUF Slot | | 0 . . . 1 | | | | |
| Configuration List | | | | | | |
| >DUF Slot | | 1 . . . | | The | — | |
| Configuration Item | | <maxnoofDUFSlots> | | maxNrofSlots | | |
| | | | | in TS | | |
| | | | | 38.331 [8]. | | |
| >>CHOICE DUF | M | | | | — | |
| Slot Configuration | | | | | | |
| >>>Explicit Format | | | | | — | |
| >>>>Permutation | M | | ENUMERATED | | — | |
| | | | (DFU, UFD, . . . ) | | | |
| >>>>Number of | O | | INTEGER | | — | |
| Downlink Symbols | | | (0 . . . 14) | | | |
| >>>>Number of | O | | INTEGER | | — | |
| Uplink Symbols | | | (0 . . . 14) | | | |
| >>>Implicit Format | | | | | | |
| >>>>DUF Slot | M | | INTEGER | Index into | — | |
| Format Index | | | (0 . . . 254) | Table 11.1.1-x | | |
| | | | | and Table | | |
| | | | | 14-1 in TS | | |
| | | | | 38.213 [31], | | |
| | | | | excluding the | | |
| | | | | last row. | | |
| HSNA | M | | ENUMERATED | | YES | reject |
| Transmission | | | (ms0p5, ms0p625, | | | |
| Periodicity | | | ms1, ms1p25, ms2, | | | |
| | | | ms2p5, ms5, ms10, | | | |
| | | | ms20, ms40, ms80, | | | |
| | | | ms160, . . . ) | | | |
| HSNA Slot | | 0 . . . 1 | | | | |
| Configuration List | | | | | | |
| >HSNA Slot | | 1 . . . | | | | |
| Configuration Item | | <maxnoofHSNASlots> | | | | |
| >>HSNA | O | | ENUMERATED | HSNA value | — | |
| Downlink | | | (HARD, SOFT, | for downlink | | |
| | | | NOTAVAILABLE) | symbols in | | |
| | | | | a slot. | | |
| >>HSNA Uplink | O | | ENUMERATED | HSNA value | — | |
| | | | (HARD, SOFT, | for uplink | | |
| | | | NOTAVAILABLE) | symbols in | | |
| | | | | a slot. | | |
| >>HSNA Flexible | O | | ENUMERATED | HSNA value | — | |
| | | | (HARD, SOFT, | for flexible | | |
| | | | NOTAVAILABLE) | symbols in | | |
| | | | | a slot. | | |

| Range bound | Explanation |
|---|---|
| maxnoofDUFSlots | Maximum no. of slots in 10 ms. Value is 320. |
| maxnoofSymbols | Maximum no. of symbols in a slot. Value is 14. |
| maxnoofHSNASlots | Maximum no of “Hard”, “Soft” or “Not available” |
| | slots in 160 ms. Value is 5120. |

Regarding resource configuration in NR Rel-15, Dynamic TDD was introduced in NR through RRC configurations and lower layer control signaling. It allows NR systems to enjoy more flexible slot formats for TDD operation that can be modified dynamically for adaptation to varying traffic. RRC can configure slots for TDD operation by the following IEs [38.213, 38.331]:

TDD-UL-DL-ConfigCommon: This IE determines a cell-specific Uplink/Downlink TDD configuration. The IE contains a periodicity value between 0.5 ms to 10 ms and a reference subcarrier spacing (SCS). A slot configuration pattern (through one or two pattern fields) are then defined within the periodicity. The periodicity may contain multiple slots. The most general pattern for each periodicity is a number of downlink slots and symbols at the beginning and a number of uplink symbols and slots at the end. All the remaining slots and/or symbols in between are flexible and can be overridden by the following UE-specific configuration.

TDD-UL-DL-ConfigDedicated: This IE determines a UE-specific Uplink/Downlink TDD configuration. The IE configures a number of slot configurations. Each slots configuration contains an index based on the periodicity defined by the cell-specific configuration, and a number of downlink and uplink symbols in the slot, which can override flexible symbols configured by the cell-specific configuration.

Furthermore, resources that are still flexible (e.g., not configured downlink or uplink) by the cell-specific or UE-specific configuration can be dynamically indicated downlink or uplink by a DCI format 2_0 for a UE or a group of UEs. The DCI can contain slot format indicators (SFIs), each an index to a table of slot formats configured by the RRC. The configuration from the RRC refers to each slot format by an 8-bit number.

In NR Rel-15, 56 of the 256 possible values (indexed 0-55) were used to define slot formats of various combinations. The general format for each of the slot formats is DL-F-UL, where a slot format may contain one, two, or all the three types of the symbols with various numbers in the specified order. Later, in NR Rel-16, 41 more values (indexed 56-96) were used for UL-F-DL formats for IAB that provide further flexibility for an IAB node that may want to start a slot with uplink symbols followed by downlink symbols.

Finally, resources that are not configured or indicated downlink or uplink by any of the above signaling should be assumed reserved, which allows flexibility for cell management, coexistence, and so on.

Regarding resource configuration in NR IAB Rel-16, as mentioned previously, more slot formats were introduced in NR IAB Rel-16 to allow higher flexibility.

Furthermore, resources can be configured as hard (H), soft(S), or not available (NA). Hard resources can be assumed available for scheduling by the IAB node and NA resources cannot be assumed available, while soft resources can be indicated available or not available dynamically. Dynamic availability indication (AI) for soft resources can be performed by DCI format 2_5 from a parent IAB node/donor and has similarities in formats and definitions with SFI (DCI format 2_0).

There were proposals that resources can be shared between backhaul and access links, which can be configured semi-statically by the CU (IAB donor at layer-3) or dynamically by DU (parent IAB node at layer-1). Multiplexing between backhaul link and access link resources can be TDM, FDM, or allow time-frequency resource sharing. Furthermore, resources can be allocated exactly (per node or per link) or in the form of a resource pool. Nokia had a mention of a resource pool approach as well.

There were proposals to allow semi-static configuration at layer-2 or layer-3 for sharing resources between backhaul and access. It should be noted that in this TDoc and the previously mentioned TDocs, the emphasis is on configuration of resources for backhaul vs. access rather than upstream vs. downstream. However, under dynamic scheduling, this TDoc does briefly suggest that an IAB node can use the resources not used by the parent IAB node for backhaul in order to schedule the access link.

Semi-static vs. dynamic resource coordination approaches are briefly mentioned in some proposals. There were proposals for “flexible partitioning” of resources in time and frequency domains. It also proposes to use ‘F’ (flexible) in DCI 2_0 and a new state ‘A’ (access) for determining slot format and sharing resources with the access link. The proposals are similar to the use of hard and soft configurations and availability indication in IAB Rel-16. Nokia had a similar proposal.

Some proposals distinguish “inter-panel” from “intra-panel” FDM and SDM. Power limitations and timing requirements are briefly mentioned for each case.

The following DCI formats are defined in the specification of NR Rel-15/16 [TS 38.212]:

| DCI format | Usage |
|---|---|
| 0_0 | Scheduling of PUSCH in one cell |
| 0_1 | Scheduling of one or multiple PUSCH in one |
| | cell, or indicating downlink feedback |
| | information for configured grant PUSCH (CG- |
| | DFI) |
| 0_2 | Scheduling of PUSCH in one cell |
| 1_0 | Scheduling of PDSCH in one cell |
| 1_1 | Scheduling of PDSCH in one cell, and/or |
| | triggering one shot HARQ-ACK codebook |
| | feedback |
| 1_2 | Scheduling of PDSCH in one cell |
| 2_0 | Notifying a group of UEs of the slot format, |
| | available RB sets, COT duration and search |
| | space set group switching |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |
| 2_4 | Notifying a group of UEs of the PRB(s) and |
| | OFDM symbol(s) where UE cancels the |
| | corresponding UL transmission from the UE |
| 2_5 | Notifying the availability of soft resources as |
| | defined in Clause 9.3.1 of [10, TS 38.473] |
| 2_6 | Notifying the power saving information outside |
| | DRX Active Time for one or more UEs |
| 3_0 | Scheduling of NR sidelink in one cell |
| 3_1 | Scheduling of LTE sidelink in one cell |

In this disclosure, a DCI message scheduling a physical uplink shared channel (“PUSCH”) may refer to a DCI format 0_0, 0_1, or 0_2; a DCI message scheduling a physical downlink shared channel (“PDSCH”) may refer to a DCI format 1_0, 1_1, or 1_2; a slot format indication (“SFI”) message may refer to a DCI format 2_0; and an availability indication (AI) message may refer to a DCI format 2_5.

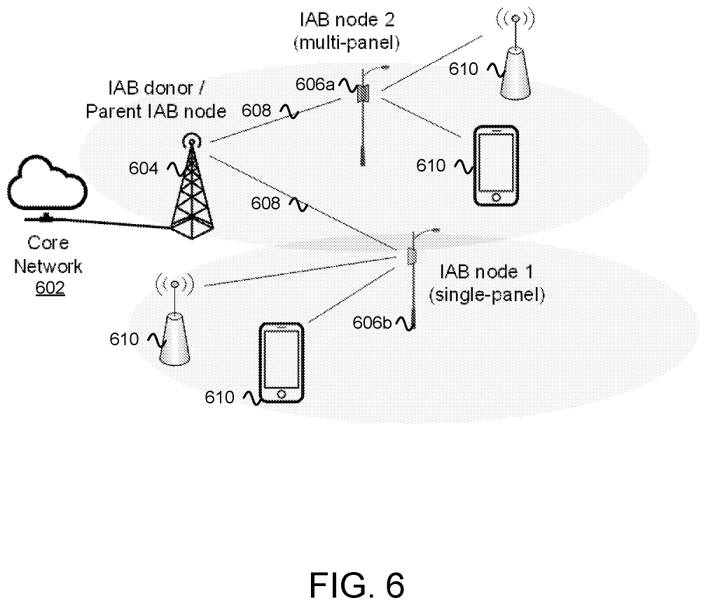

In general, an IAB system is connected to a core network 602 through one or multiple IAB donors 604. Each IAB node 606 may be connected to an IAB donor 604 and/or other IAB nodes 606 through wireless backhaul links 608. Each IAB donor/node 604 may also serve UEs 610. Consider the example IAB system illustrated in FIG. 6.

There are various options with regards to the structure and multiplexing/duplexing capabilities of an IAB node 606. For example, each IAB node 606 may have one 606a or multiple 606b antenna panels, each connected to the baseband unit through an RF chain. The one or multiple antenna panels may be able to serve a wide spatial area of interest in a vicinity of the IAB node 606, or otherwise each antenna panel or each group of antenna panels may provide a partial coverage such as a “sector.” An IAB node with multiple antenna panels 606a, each serving a separate spatial area or sector, may still be referred to as a single-panel IAB node 606b as it behaves similarly to a single-panel IAB node 606b for communications in each of the separate spatial areas or sectors.

Furthermore, each antenna panel may be half-duplex (“HD”), meaning that it is able to either transmit or receive signals in a frequency band at a time, or full-duplex (“FD”), meaning that it is able to both transmit and receive signals in a frequency band simultaneously. Unlike full-duplex radio, half-duplex radio is widely implemented and used in practice and is usually assumed as the default mode of operation in wireless systems.

The following table lists different duplexing scenarios of interest when multiplexing is not constrained to time-division multiplexing (“TDM”). In this table, single-panel and multi-panel IAB nodes are considered for different cases of simultaneous transmission and/or reception. Spatial-division multiplexing (“SDM”) refers to either transmission or reception on downlink (or downstream) and uplink (or upstream) simultaneously; full duplex (“FD”) refers to simultaneous transmission and reception by a same antenna panel in a frequency band; and multi-panel transmission and reception (“MPTR”) refers to simultaneous transmission and/or reception by multiple antenna panels where each antenna panel either transmits or receives in a frequency band at a time.

| | Architecture / | Simultaneous | | | |
|---|---|---|---|---|---|
| Case# | Capability | TX/RX Type | IAB-MT | IAB-DU | Scenario# |
| Case A / | Single-panel | TX SDM | UL-TX | DL-TX | S3 |
| Case#1 | Multi-panel | TX | UL-TX | DL-TX | S7 |
| | | MPTR/SDM | | | |
| Case B / | Single-panel | RX SDM | DL-RX | UL-RX | S1 |
| Case#2 | Multi-panel | RX | DL-RX | UL-RX | S5 |
| | | MPTR/SDM | | | |
| Case C / | Single-panel | UL FD | UL-TX | UL-RX | S4 |
| Case#3 | Multi-panel | UL | UL-TX | UL-RX | S8 |
| | | MPTR/FD | | | |
| Case D / | Single-panel | DL FD | DL-RX | DL-TX | S2 |
| Case#4 | Multi-panel | DL | DL-RX | DL-TX | S6 |
| | | MPTR/FD | | | |

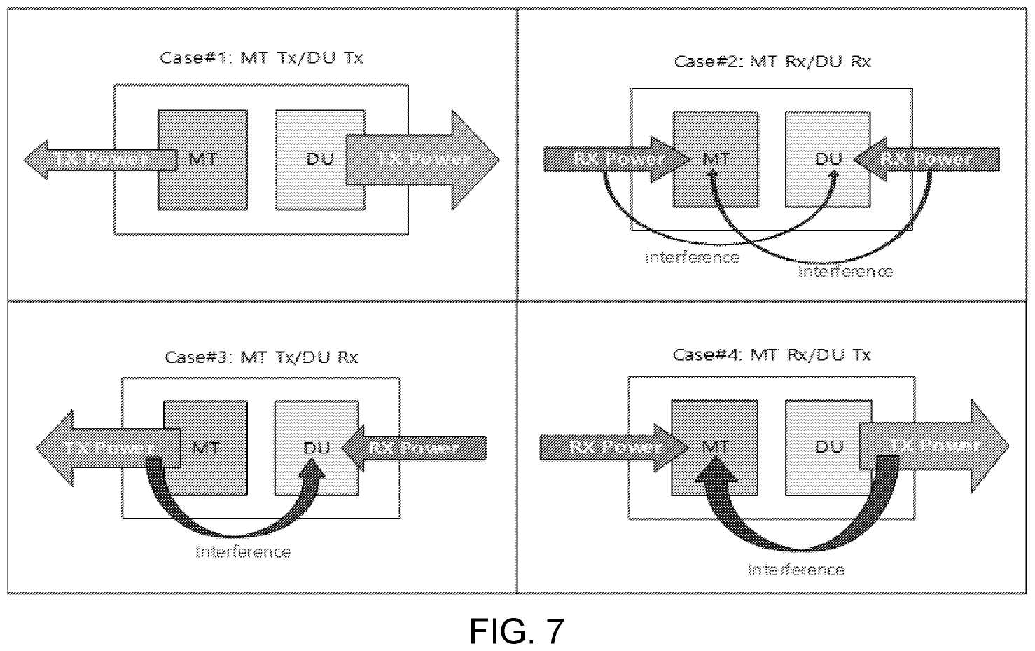

In the above table, based on the type of simultaneous operations and the number of panels in an IAB node, the scenarios are called S1, S2, . . . , S8 in accordance with our previous disclosures, while the “Case” numbers (A/B/C/D or 1/2/3/4) are in accordance with the FIG. 7.

In this disclosure, scenarios may be referred to by their Case #or Scenario #according to the presented table.

Regarding the solution proposed herein for enhanced soft resource management, it was agreed in RAN1 to extend the H/S/NA framework to the frequency domain as starting point for resource multiplexing enhancements. Extensions to configuration and availability signaling for soft resource are proposed in this section.

Consider an IAB-DU providing a cell C with an active bandwidth part (“BWP”) B comprising N physical resource blocks (“PRBs”) in the frequency domain.

The first matter is a granularity for resources in the frequency-domain.

In some embodiments, the granularity may be one PRB. In this case, a resource configuration or signaling may determine an attribute such as D/U/F or H/S/NA for each of the N PRBs.

In some embodiments, the granularity may be a constant number of PRBs. In this case, a resource configuration or signaling may determine an attribute such as D/U/F or H/S/NA for a group of M PRBs.

In some embodiments, the M PRBs may be contiguous, determined for example by a start PRB number m, from the beginning of the active BWP B, and a number of PRBs M. In this case, a resource block group (RBG) may comprise PRBs m, m+1, m+2, . . . , m+M−1. The values of m and M may be determined by a configuration of the RBG. Multiple of such RBG may be configured.

In order to reduce the overhead of configuration or signaling, the N PRBs (numbered 0, 1, . . . , N−1) in the BWP may be divided into RBGs of M PRBs by sending a configuration comprising one vale of M. Then:
a. RBG #0 comprises PRBs 0, 1, . . . , M−1
b. RBG #1 comprises PRBs M, M+1, . . . , 2M−1
c . . .
d. RBG #n comprises PRBs n.M, n.M+1, . . . , (n+1).M−1
e. . . .
and so on. The PRBs may be numbered from the first (lowest frequency) PRB of the active BWP. In the case that N is not an integer multiple of M, a number of remaining PRBs smaller than M may be considered as the last RBG, resulting in [N/M] RBGs, or may be omitted, resulting in [N/M] RBGs.

Since the IAB-DU may be serving several UEs or IAB-MTs with different BWPs, it may be more efficient to start the first PRB of RBG #0 at a PRB other than the first PRB of the active BWP. In an embodiment, a starting PRB number m may be configured per BWP B. Then, RBG #0 starts from PRB m, RBG #1 starts from PRB m+M, and so on. The starting PRB number m may be referred to as an offset and may be configured or indicated per BWP. In some embodiments, a nonzero number of PRBs smaller than M at the lowest or the highest frequencies of the BWP may be used as an RBG or left unused.

In the above embodiments, RBGs are configured up to the PRB with the highest frequency, e.g., PRB N−1. In some embodiments, a PRB number N′−1 may also be determined by a configuration as the highest PRB number for a configuration of RBGs. In a general case, a configuration may comprise a first PRB number m, a last PRB number N′−1, and a number of PRBs M in each RBG. Then, multiple of such configurations may be used to cover an arbitrary part of the BWP by an arbitrary granularity. Each RBG may be indicated by an identifier (ID) of a configuration and an RBG number.

In order to provide flexibility, configuration IEs may configure RBGs on overlapping resources. In an embodiment, as a special case, a first configuration IE from an IAB-CU may configure RBGs of a first number of PRBs on a BWP while a second configuration IE from the IAB-CU may configure RBGs of a second number of PRBs on the BWP. In another embodiment, the configuration IEs may be from different IAB-CUs, e.g., in the case of intra-carrier inter-donor DC.

If overlapping resources are used in different configurations, rules may apply to how attributes such as D/U/F or H/S/NA or availability of soft resources are configured or signaled:
a. In an embodiment, an IAB-DU is not expected to receive configurations on overlapping resources.
b. In another embodiment, if an IAB-DU receives configurations on overlapping resources, it may prioritize one over the other. For example, the configuration received later may take a higher priority. In the case of inter-donor DC, a configuration from an IAB-CU configuring a master parent node may take a higher priority. In the case of intra-donor DC, a configuration received through a master parent node may take a higher priority.
c. In yet another embodiment, if an IAB-DU receives a configuration and a control signaling for overlapping resources, the control signaling is not expected to contradict the configuration on any of the overlapping resources.
d. In yet another embodiment, if an IAB-DU receives a configuration and a control signaling for overlapping resources, the control signaling overrides the configuration for a one occurrence or one periodicity.
e. In yet another embodiment, if an IAB-DU receives multiple control signaling for overlapping resources, the IAB-DU does not expect the control signaling to provide contradicting information for any of the overlapping resources. In yet another embodiment, a control signaling such as the one received earliest or latest may take a higher priority.

In some embodiments, a grouping of PRBs may be hierarchical or applied at multiple levels. For example, a group of N PRBs may be used as a unit of frequency/bandwidth, while a plurality of the said units may be assigned an attribute, such as D/U/F or H/S/NA or indicated available or conditionally available as described in the next sections.

In some embodiments, the M PRBs may be noncontiguous, determined for example by a set of PRBs or RBGs or a pattern of PRBs or RBGs. The pattern may be determined by the standard or a configuration.

In embodiments presented herein, a PRB as a unit of frequency or bandwidth may be considered in reference to a reference subcarrier spacing (SCS) in an Orthogonal Frequency Division Multiplexing (“OFDM”) numerology specified in the standard. For example, for SCS=15 kHz, a PRB is 12*15 kHz=180 kHz. If a larger SCS such as 30 kHz, 60 kHz, 120 kHz, etc. is the reference SCS, then the node receiving a configuration or control signaling may interpret a PRB as 360 kHz, 720 kHz, 1440 kHz, etc.

In some embodiments, if more than one OFDM numerology is used for communications, a node may interpret a PRB in reference to a reference SCS as indicated by a configuration or a control signaling. Alternatively, in some embodiments, if more than one OFDM numerology is used for communications, a node receiving a configuration or control signaling for a resource (such as a D/U/F/H/S/NA attribute or an availability indication) may interpret a PRB in reference to an SCS associated with a resource in which the control signaling is received, the resource to which the attribute or availability indication is applied, the active BWP, the master link in a dual-connectivity or multi-parent scheme, or a like.

The second matter is the duration for which a soft resource in the frequency domain may be indicated available.

In an embodiment, a soft resource in the frequency domain may be indicated available for a periodicity. The periodicity may be determined by an existing field such as DUF Transmission Periodicity or HSNA Transmission Periodicity in a gNB-DU Cell Resource configuration. Alternatively, a periodicity or duration may be configured by a field in a configuration or indicated by a control signaling.

The third matter is the format of configuration IEs and control signaling messages.

In some embodiments, a configuration or signaling for a frequency-domain resource may be comprised by a or joint with a time-domain configuration or signaling. For example, a configuration IE may comprise fields for both time-domain and frequency-domain configurations. Another example is that a control signaling such as an SFI (in a DCI message with format 2_0) or an AI (in a DCI message with format 2_5) is enhanced to comprise to frequency-domain information in addition to time-domain information in the same message. In these cases, resources in the time-frequency grid, for example bound by a periodicity in the time domain and a BWP in the frequency-domain, may be partitioned and configured/indicated separately.

In alternative embodiments, a configuration or signaling for a frequency-domain resource may be separate from a time-domain configuration or signaling. In this case, a resource in the time-frequency grid may take its attributes such as D/U/F, H/S/NA, or an availability indication if the resource is soft, from a combination of configurations and signaling messages.

In an embodiment, if a symbol is configured flexible (F) by a first configuration, a PRB on the symbol may be configured DL or UL by a second configuration or indicated DL or UL by a control message. Whether PRBs on a symbol may be configured or indicated DL and UL may depend on an IAB node's capability to perform simultaneous operations and/or on whether conditions on beamforming, power, interference, timing alignment, or a like are satisfied.

Whether one PRB on a symbol may be configured or indicated DL and UL may depend on an IAB node's capability to perform simultaneous operations, such as an SDM or multi-panel capability, and/or on whether conditions on beamforming, power, interference, timing alignment, or a like are satisfied.

Whether multiple PRBs on a symbol may be configured or indicated DL and UL may depend on an IAB node's capability to perform simultaneous operations, such as an FDM or SDM capability, and/or on whether conditions on beamforming, power, interference, timing alignment, or a like are satisfied.

In an embodiment, if a symbol is configured hard (H) or soft(S) or not-available (NA) by a first configuration, a PRB on the symbol may be configured H or S or NA by a second configuration. Rules may apply to cases that information from a first configuration and a second configuration is not similar.

In one realization, if a symbol is configured H or NA, a PRB on the symbol may not be configured S. A contradiction as such may not be expected by the IAB-DU or may be ignored by the IAB-DU. In another realization, if a symbol is configured S, a PRB on the symbol may be configured H/S/NA, in which case the PRB is interpreted as H/S/NA, respectively. In yet another realization, if a symbol is configured H, a PRB on the symbol may only be configured H or NA. In yet another realization, if a symbol is configured NA, a PRB on the symbol may not be configured H or S. Other such rules, which may be enforced by an IAB-CU or handled by the IAB-DU, are not precluded.

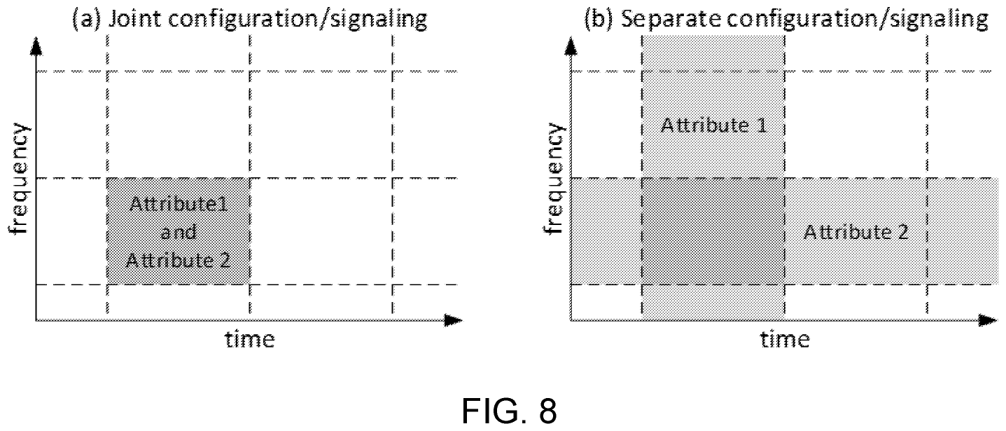

Regarding availability indication for frequency resources, in one embodiment, as mentioned in the previous subsection, configuration and control signaling such as SFI and AI for frequency-domain resources may be joint with a time-domain counterpart, in which case the configuration or signaling applies to a resource partition in the time-frequency grid, or may be separate from a time-domain counterpart, in which case an attribute of a resource may be determined by a combination of configurations or control messages. The two approaches are illustrated in FIG. 8.

In FIG. 8, Attribute 1 may be taken from a first configuration/signaling in the time-domain, which may be similar to a configuration/signaling in a Rel-15/16 legacy system; while Attribute 2 may be taken from a second configuration/signaling in the frequency-domain, which may be a new configuration/signaling. In case (a), the attributes apply to the same partition of resources in the time-frequency grid. In case (b), however, the two attributes apply to a larger range of resources in each domain. In the latter case, a behavior of the node may be determined by a combination of the attributes from the configurations or signaling messages as well as rules specified by the standard, configured by the network, or determined by an implementation.

Therefore, in this subsection, we focus on frequency-domain enhancements independent of whether they apply to time-frequency resources according to approach (a) or approach (b).

In any of the embodiments presented herein, a unit of frequency referred to as a resource block group (RBG) may be a fixed number N of contiguous PRBs, a number of noncontiguous PRBs, a number of RBGs (referred to as an RBG Group), or a like.

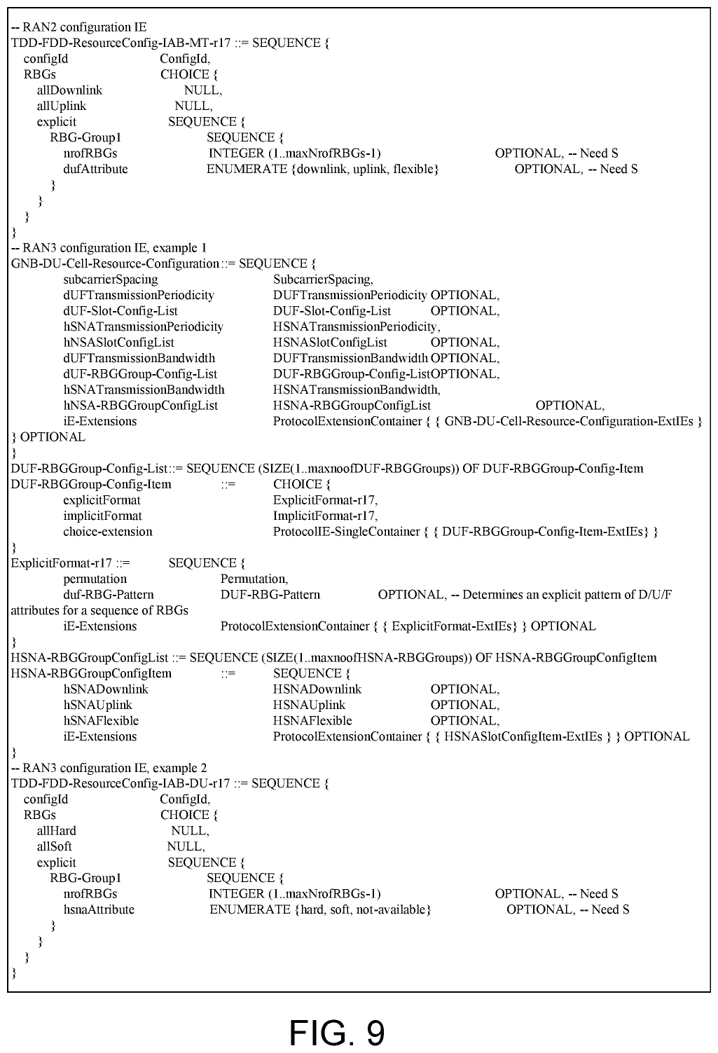

In some embodiments, a configuration of resources may assign an attribute such as a D/U/F or an H/S/NA attribute to one or a plurality of RBGs. FIG. 9 provides an example ASN.1 code.

In some embodiments, frequency-domain availability combinations are defined with relationships that may share similarities with time-domain availability combinations specified for IAB Rel-16.

| Configuration IE for IAB Rel-17 (in | Configuration IE for IAB Rel-16 (in time |
|---|---|
| frequency domain or time-frequency domain) | domain) |
| AvailabilityCombinationsPerCell-r17 | AvailabilityCombinationsPerCell-r16 |
| AvailabilityCombinationsPerCellIndex-r17 | AvailabilityCombinationsPerCellIndex-r16 |
| AvailabilityCombination-r17 | AvailabilityCombination-r16 |
| AvailabilityCombinationId-r17 | AvailabilityCombinationId-r16 |
| AvailabilityIndicator-r17 | AvailabilityIndicator-r16 |
| AI-RNTI-r16 (reused), AI-RNTI-r17 | AI-RNTI-r16 |

In some embodiments, each frequency-domain availability combination defined by IEs in the first column may be associated with all the soft resources that are downlink, uplink, or flexible in a frequency range.

Alternatively, in some embodiments, each frequency-domain availability combination defined by IEs in the first column may be associated with all soft resources in a sub-band (or sub-range) of frequency range.

As yet another alternative, in some embodiments, each frequency-domain availability combination defined by IEs in the first column may be associated with a number of PRBs or a number of RBGs (also referred to as an RBG Group).

As yet another alternative, in some embodiments, each frequency-domain availability combination defined by IEs in the first column may be associated with an arbitrary pattern of PRBs, RBGs, RBG Groups, or a like. The pattern may be specified by the standard or indicated by a bitmap, wherein a ‘1’ in the bitmap may determine that an associated PRB, an RBG, or a group of RBGs belongs to the availability combination, while a ‘0’ in the bitmap may determine that an associated PRB, an RBG, or a group of RBGs does not belong to the availability combination.

It should be noted that in a configuration IE, a bitmap may be realized as a SEQUENCE of fields, mandatory or optional, wherein each field in the SEQUENCE may be of type ENUMERATED {′0′, ‘1’} or a similar enumerated type.

In some embodiments, since a length of the bitmap field may be a constant M, the availability combination may split the bandwidth in a frequency range to M parts, and then each bit corresponds to a part in the frequency range. The constant M may be configurable. When the frequency range is specified, for example, in units of PRBs, a floor function or a ceiling function may be applied to determine each of the M parts as an integer multiple of a PRB.

Regarding control signaling, in one embodiment, a specification such as the following may be adopted for availability indication, or conditional availability indication, in the frequency domain (separate signaling) or the time-frequency-domain (joint signaling). The following may be used to modify a specification such as Section 14 of TS 38.213.

In one embodiment, if an IAB-node is provided an AvailabilityIndicator-r17, the IAB-node is provided an AI-RNTI by ai-RNTI-r16 or ai-RNTI-r17 and a payload size of a DCI format 2_5 by dci-PayloadSizeAI. The IAB-node is also provided a search space set configuration, by SearchSpace, for monitoring PDCCH.

For each cell of an IAB-DU in a set of cells of the IAB-DU, the IAB-DU can be provided:
a. an identity of the IAB-DU cell by iab-DU-CellIdentity
b. a location of a frequency-domain availability indicator (AI) index field in DCI format 2_5 by positionInDCI-AI-r17
c. a set of availability combinations by availabilityCombinations-r17, where each availability combination in the set of availability combinations includes
   i. resourceAvailability-r17 indicating availability of soft symbols in one or more PRBs, RBGs, RBG Groups, or a like for the IAB-DU cell, and
   ii. a mapping for the soft resource availability combinations provided by resourceAvailability-r17 to a corresponding AI index field value in DCI format 2_5 provided by availability CombinationId-r17

The IAB-DU can assume a same subcarrier spacing (“SCS”) configuration for availabilityCombinations-r17 for a cell as an SCS configuration provided by gNB-DU Cell Resource Configuration for the cell.

In one embodiment, an AI index field value in a DCI format 2_5 indicates to an IAB-DU a soft resource availability in a plurality of resources in the frequency domain or in time and frequency domains for a number of slots starting from the earliest slot of the IAB-DU which overlaps in time with the slot of the IAB-MT where the IAB-MT detects the DCI format 2_5, where the number of slots may be equal to or larger than a PDCCH monitoring periodicity for DCI format 2_5 as provided by SearchSpace. Alternatively, an availability indication in the frequency domain may remain valid until another control signaling such as another DCI 2_5 is received. The AI index field may be provided by corresponding availabilityCombinationId-r17. An availability for a soft resource may be identified by a corresponding value resourceAvailability-17, e.g., as provided in Table 14-3 of TS 38.213, according to a bitmap similar to the bitmap proposed for availability combination configurations, or a like.

In one embodiment, if a PDCCH monitoring periodicity for DCI format 2_5 is smaller than a duration of an availability combination of soft resources that the IAB-MT obtains at a PDCCH monitoring occasion for DCI format 2_5 by a corresponding AI index field value, and the IAB-MT detects more than one DCI formats 2_5 indicating an availability combination of soft resources, the IAB-MT expects that each of the more than one DCI formats 2_5 indicates a same value for the availability combination of the soft resources. An IAB-MT monitors PDCCH candidates for a DCI format 2_5 with CRC scrambled by AI-RNTI-16 or AI-RNTI-17 in one or both of the following search space sets:
a. a Type3-PDCCH CSS set configured by SearchSpace in PDCCH-Config with searchSpaceType=common;
b. a USS set configured by SearchSpace in PDCCH-Config with searchSpaceType=ue-Specific.

In some embodiments, a DCI 2_5 for a frequency-domain availability combination or a time-frequency-domain availability combination may be scrambled by an AI-RNTI-r17 that is different from the AI-RNTI used for scrambling a DCI 2_5 for a time-domain availability indication as specified for Rel-16.

Regarding conditional availability indication, previously, systems and methods were proposed for enabling simultaneous operations for IAB systems with enhanced duplexing capabilities. Several embodiments have been proposed based on control signaling with adjacent nodes such as parent and child nodes in order to share resources between upstream and downstream links of an IAB node flexibly and efficiently.

In this disclosure, systems and methods based on availability indication are proposed.

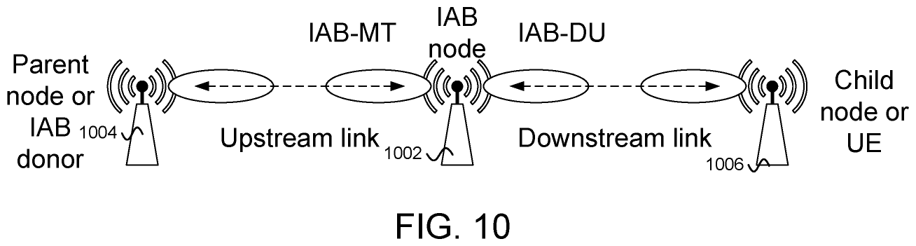

Consider a generic scenario in an IAB system as illustrated in FIG. 10. In this figure, an IAB node 1002 is served by a parent node or an IAB donor 1004 and may serve a child node or a UE 1006.

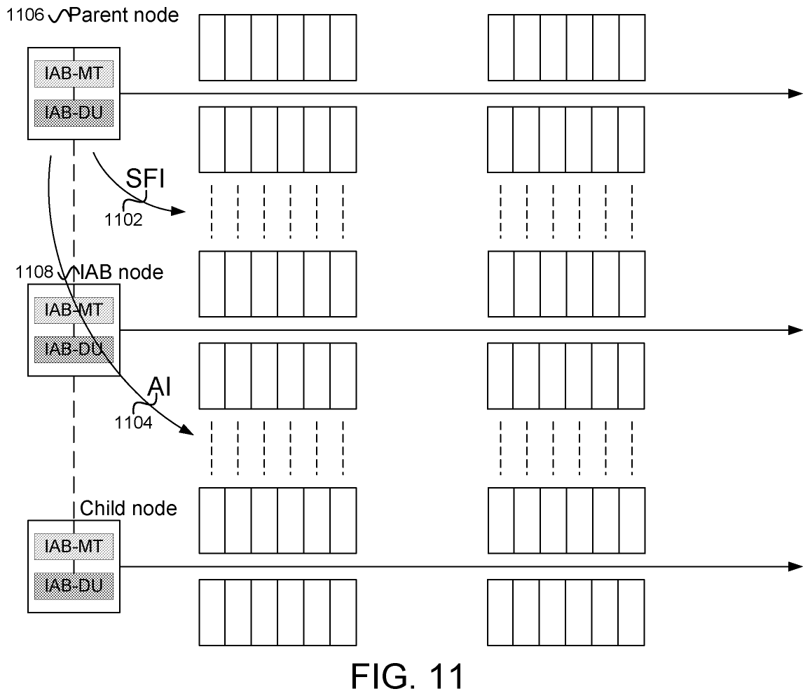

FIG. 11 shows the relationship between how the SFI 1102 and AI 1104 messages may provide more control to the parent node 1106 over resources in an upstream link and a downstream link of the IAB node 1108, respectively.

The following specification, e.g., from TS 38.213, explains how a control signaling from a parent node takes priority for the case of soft resources:

In one embodiment, when a downlink, uplink, or flexible symbol is configured as soft, the IAB-DU can respectively transmit, receive or either transmit or receive in the symbol only if:
a. the IAB-MT does not transmit or receive in the symbol, or
b. the IAB-MT would transmit or receive in the symbol, and the transmission or reception in the symbol is not changed due to a use of the symbol by the IAB-DU, or
c. the IAB-MT detects a DCI format 2_5 with an AI index field value indicating the soft symbol as available

In the above specification, the second condition states that a schedule for IAB-MT, whether configured by the IAB-CU or signaled by the parent node, takes a higher priority than a TX/RX by the IAB-DU. The third condition states that an availability indication (AI) signaling from the parent node may determine whether the IAB-DU transmits or receives. In both cases, a signaling from the parent node takes a higher priority.

Enhanced IAB (“eIAB”) nodes, in one embodiment, are expected to be capable of enhanced duplexing to perform simultaneous operations (TX and/or RX) in downstream and upstream links. This capability may refer to a hardware, firmware, or software capability such as possessing multiple panels, applying multiple beams (spatial filters), or possessing multiple inverse discrete Fourier transform (“IDFT”)/DFT windows for OFDM.

However, in one embodiment, conditions such as alignment of beams that may be used for simultaneous operations, power imbalance and total power constraints applicable to a node or antenna panel if the simultaneous operations are to be performed, interference constraints, timing alignment constraints, and the like a may or may not allow an otherwise capable IAB node to accommodate both operations simultaneously. These conditions may change momentarily before a timely decision may be made according to the aforementioned conditions in the current specification. We may refer to these conditions as “operation constraints” in order to make a distinction with hardware/firmware/software limitations that are determining factors prior to the operation.

For example, an availability indication (AI) may indicate soft resources in tens of slots available to an IAB node; then, according to the current specification, if a condition on beams, power, interference, timing, or the like stops to hold, the IAB node may continue to schedule communications on the soft resources even if that is at the cost of starvation of resources for the upstream link. The IAB node may, of course, maintain a balance between resources used for upstream and downstream, but that is only up to the implementation and does not provide sufficient control for the system to manage the resources more efficiently.

Embodiments of the present disclosure deviate from the above principle and aim at striking a balance between upstream and downstream resources when the conditions for performing simultaneous operations may be variable or unpredictable. This feature may be especially useful for mobile IAB where mobility may continuously change any or all of constraints on beamforming, power, interference, timing alignment, and so on.

The following embodiments may be applied to indicating availability of soft resources in the time domain and/or the frequency domain as specified in the standard and proposed in the previous sections. Therefore, as examples, a “resource” may refer to:
a. a resource indicated in the time domain such as a symbol, a group of symbols in a slot, a slot, a mini-slot, a group of slots, etc.
b. a resource indicated in the frequency domain such as a PRB, a number of PRBs, an RBG, a sub-channel, a partition of a BWP, etc.
c. a resource indicated in both time and frequency domains by a joint configuration/signal or by separate configuration/signaling.

In some embodiments, an availability indication (AI) may indicate to an IAB node that a soft resource is available provided that one or multiple condition holds. For the sake of clarity, this AI signaling may be called a conditional AI (CAI) although it may be referred to by the generic term AI in the standard. In the present disclosure, a soft resource that is indicated available (IA) by a CAI may be referred to as a C-IA resource and a soft resource indicated not-available (INA) by a CAI may be referred to as C-INA.

In an embodiment, a C-IA resource is available to an IAB-DU of an IAB node if an IAB-MT of the IAB node is capable of an operation. An operation may refer to a transmission and/or a reception. Whether the operation is a transmission or is a reception may be determined by a direction configured or indicated by a signaling.

Herein, the word “configured” may mean configured by a resource configuration, a signal/channel configuration, and so on; and the word “indicated” may mean signaled or indicated by a control signaling message such as an SFI, a DCI scheduling a PDSCH, a DCI scheduling a PUSCH, a MAC message, and so on.

In one embodiment, if a resource is configured/indicated DL for the IAB-MT (upstream), the C-IA resource (similar or same characteristic as the resource for the IAB-MT, at least overlapping with the resource for the IAB-MT) is available for a TX/RX by the IAB-DU (downstream) if the TX/RX can be performed simultaneously with an RX by the IAB-MT.

In one embodiment, if a resource is configured/indicated UL for the IAB-MT (upstream), the C-IA resource is available for a TX/RX by the IAB-DU (downstream) if the TX/RX can be performed simultaneously with a TX by the IAB-MT.

In one embodiment, if a resource is configured/indicated flexible (F) for the IAB-MT (upstream), the C-IA resource is available for a TX/RX by the IAB-DU (downstream) if the TX/RX can be performed simultaneously with any of TX or RX by the IAB-MT.

In another embodiment, if a resource is configured/indicated flexible (F) for the IAB-MT (upstream), the C-IA resource is available for a TX/RX by the IAB-DU (downstream) if the TX/RX can be performed simultaneously with either TX or RX by the IAB-MT.

In yet another embodiment, if a resource is configured/indicated flexible (F) for the IAB-MT (upstream), the C-IA resource is available for a TX/RX by the IAB-DU (downstream) unconditionally.

In yet another embodiment, if a resource is configured/indicated flexible (F) for the IAB-MT (upstream), the C-IA resource is not available for a TX/RX by the IAB-DU (downstream) at least until further signaling indicates a direction (DL or UL) for the resource for the IAB-MT.

In another embodiment, a (C-IA) resource is considered available for a TX/RX by the IAB-DU (downstream) if the TX/RX can be performed simultaneously with any of TX or RX by the IAB-MT on the resource. Such resource may not have an availability indication (AI).

Determining which of the above realizations is applicable may be determined by the standard, a configuration, or a signaling.

It should be noted that in any of these embodiments, a conditional availability may also depend on a simultaneous operation capability of the IAB node and whether the intended downstream operation is a TX or an RX. For example, an IAB node with a single half-duplex antenna panel may not be capable of simultaneous TX and RX in any direction. Therefore, the IAB node may not be able to use a C-IA DL resource at downstream if a time-overlapping resource is configured/indicated DL at the upstream. However, the same IAB node may be capable of performing simultaneous TX, in which case a C-IA DL resource at downstream is available if a time-overlapping resource is configured/indicated UL at the upstream. This approach may determine a DL/UL direction for a flexible (F) resource implicitly—for a single-panel half-duplex IAB node, a C-IA F resource at downstream may be available only for a DL transmission (not a UL reception) if an overlapping resource is configured/indicated UL at the upstream.

Since a parent node of an IAB node may be unaware of how many of C-IA resources the IAB node may have been able to use based on the IAB node capability and “operation constraints,” the IAB node may transmit a control signaling such as a UCI message of a MAC message to report a C-IA resource usage to the parent node.

As a result, a conditional availability indication as proposed in this section may be specified (or change the current specification) as follows:

When a downlink, uplink, or flexible resource is configured as soft, the IAB-DU can respectively transmit, receive or either transmit or receive in the resource only if
a. the IAB-MT does not transmit or receive in the resource, or
b. the IAB-MT would transmit or receive in the resource, and the transmission or reception in the resource is not changed due to a use of the symbol by the IAB-DU, or
c. the IAB-MT detects a DCI format 2_5 with an AI index field value indicating the soft resource as available, or
d. the IAB-MT detects a DCI format 2_5 with an AI index field value indicating the soft resource as available, and the transmission or reception in the resource is not changed due to a use of the symbol by the IAB-DU.

Regarding Inter-Donor/gNB Signaling, is has been proposed to use Xn and F1 signaling to collect information of DL and UL configurations and communications from IAB nodes and communicate the information to a gNB or IAB system in a vicinity. The information may then be used for interference management by the gNB or IAB system. This idea may be extended to cover frequency domain resource configuration and indication as well as conditional availability indication as proposed in this disclosure.

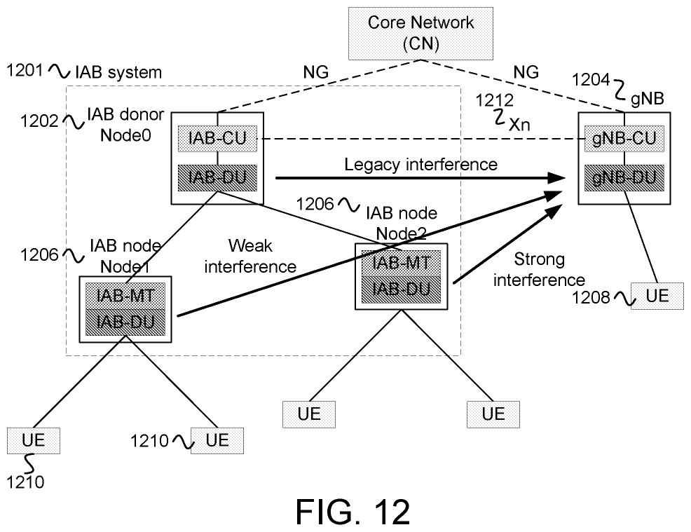

Here, a scenario is assumed where the aggressor is an IAB donor Node0 1202, and the victim is a gNB 1204, as shown in FIG. 12. Extension to other types of victim nodes such as IAB donors, IAB nodes, or other types of base stations, transmit-receive points (“TRPs”), relay nodes, access points, and so on is straight forward.

In some embodiments, Node0 1202 sends an information element containing H/S/NA configuration information to the gNB 1204.

In some embodiments, Node0 1202 may send information of dynamic availability indication (AI) and conditional availability indication (CAI) of soft resources to the gNB 1204.

In an embodiment, IAB nodes 1206 may send AI or CAI information to Node0 1202. Then, Node0 1202 may collect and send this information to the gNB 1204. According to this embodiment, the gNB 1204 obtains complete information of the usage of soft resources, possibly in advance of scheduling and beam management (TCI state indication) for the UEs 1208 it is serving, provided that the communication from IAB nodes 1206 to Node0 1202 (on an F1 interface) and from Node0 1202 to the gNB 1204 (on an Xn interface 1212) support a sufficiently high data rate and low latency.

In another embodiment, a ratio of availability indication for an IAB node 1206, or multiple IAB nodes 1206, may be sent by Node0 1202 to the gNB 1204. For example, Node0 1202 may send, to the gNB 1204, information of the number of times M that a soft resource was indicated available to an IAB node 1206 in N periodicities. The ratio M/N may then be used as an indication of traffic intensity on the soft resource in the future.

It should be noted that in any of these embodiments, a ratio such as X/Y may be communicated as a pair of scalar integers X and Y, a fixed-point real value, a floating-point real value, or a like. Alternatively, a value of Y may be determined by a specification or configuration in advance, which leaves a value of X to be communicated by signaling.

In yet another embodiment, a ratio of times that a C-IA resource was actually used may be sent by Node0 1202 to the gNB 1204. For example, Node0 1202 may send, to the gNB 1204, information of the number of times M that a soft resource was used for a communication in N periodicities or out of N times that the resource was conditionally indicated available (C-IA) for an IAB node 1206. The ratio M/N may then be used as an indication of traffic intensity on the soft resource in the future given the IAB node's capability and operation conditions.

In some embodiments, the average may be taken over multiple IAB nodes 1206. For example, Node0 1202 may send, to the gNB 1204, information of the number of IAB nodes M that a soft resource was indicated available, or the resource was used upon availability, to an IAB node 1206 in a set of N IAB nodes 1206. The ratio M/N may then be used, by the gNB 1204, as an indication of interference on the soft resource.

By extension, the average may be taken over multiple periodicities and multiple IAB nodes 1206. For example, Node0 1202 may send to the gNB 1204 information of the number of times M that a soft resource was indicated available, or used upon availability or conditional availability, to N_{N} IAB nodes 1206 in N_{P} periodicities. The ratio M/(N_{N}.N_{P}) may then be used by the gNB as an indication of interference and traffic intensity on the soft resource in the future.

Any such message comprising information of multiple configurations or signaling messages, e.g., ratio of resources indicated available or used for a DL or UL communication, may be referred to as a “digest” message in the present disclosure.

In any of the above embodiments, beam management (spatial) information such as TCI state indication may further be collected by IAB nodes 1206, over an F1 interface, and sent to the gNB 1204 for beam management purposes. Then, the gNB 1204 may combine the spatial information with the interference measurements on the associated resources and find correlations between, for example, TCI states and the level of interference they cause on the gNB 1204. This information can then be used for further signaling between the gNB 1204 and the IAB system 1201 for interference coordination or interference management purposes.

In any of the above embodiments, information associated with IAB nodes 1206 that cause a less significant interference on a victim gNB 1204 may be omitted or sent less frequently compared to information associated with IAB nodes 1206 that cause a more significant interference on a victim gNB 1204. Determining which IAB nodes 1206 may cause a more significant interference on a victim gNB 1204 may be obtained by location information, measurements by the gNB 1204, measurements by IAB nodes 1206 plus a reciprocity assumption, or a combination thereof.

The methods proposed thus far may mainly rely on signaling between IAB systems 1201 (e.g., an IAB donor) and/or base stations (e.g., gNBs) to convey information of DL/UL/F and H/S/NA configurations as well as dynamic indications that further indicate (or override) a direction of communication (DL, UL, etc.) or availability of a soft resource (is available, is not available, etc.). The problem with such methods is that their performance in terms of timely communication of the information may depend on the latency of possibly multiple wireless backhaul links (in the case of multi-hop IAB), which may not be acceptable.

An approach to address the above issue is to allow a gNB 1204 and/or an IAB node 1206 to determine information of a direction of communication and/or availability of a soft resource directly from an IAB node 1206, e.g., over the air (“OTA”). For example, the gNB 1204 or IAB node 1206 may determine such information by measuring a reference signal associated with that resource.

In some embodiments, Node0 1202 sends an information element (IE) containing information of a reference signal, such as a synchronization signal, a CSI-RS, an SRS, a reference signal for measuring cross-link interference, or a like, and an indication that associates the reference signal with a direction of transmission (DL, UL, etc.).

In an embodiment, an IAB donor Node0 1202 configures a resource for an IAB node Node1 1206 as soft(S). Furthermore, Node0 1202 configures a reference signal, such as a CSI-RS, associated with the resource. Then, if the resource is configured or indicated as DL and indicated available or conditionally available, Node1 1206 transmits the reference signal; otherwise, if the resource is not configured or indicated as DL or not indicated available or conditionally available, Node1 1206 does not transmit the reference signal. In one realization, Node1 1206 transmits the reference signal based on an alternative or additional condition that the resource is used by Node1 1206 in the downstream.

In an embodiment, an IAB donor Node0 1202 configures a resource for an IAB node Node1 1206 as soft(S). Furthermore, Node0 1202 configures a reference signal, such as an SRS, associated with the resource. Then, if the resource is configured or indicated as UL and indicated available or conditionally available, a child node or a UE 1210 served by Node1 1206 transmits the reference signal; otherwise, if the resource is not configured or indicated as UL or not indicated available or conditionally available, the child Node1 1206 does not transmit the reference signal. For this purpose, Node1 1206 may need to indicate, via a control signaling to the child node or UE 1210 to transmit the reference signal. In one realization, the child node or the UE 1210 served by Node1 1206 transmits the reference signal based on an alternative or additional condition that the resource is used by Node1 1206 in the downstream.

The two embodiments above may be combined for a resource. In an embodiment, an IAB donor Node0 1202 configures a resource for an IAB node Node1 1206 as soft(S). Furthermore, Node0 1202 configures a first reference signal, such as a CSI-RS, and a second reference signal, such as an SRS, associated with the resource. Then, if the resource is configured or indicated as DL and indicated available or conditionally available, Node1 1206 transmits the first reference signal; otherwise, if the resource is configured or indicated as UL and indicated available or conditionally available, a child node or a UE 1210 served by Node1 transmits the second reference signal; otherwise, if the resource is not configured or indicated as DL or UL or not indicated available or conditionally available, neither of the reference signals is transmitted.

Furthermore, in the above embodiments, Node1 1206, or a child node or UE 1210 served by Node1 1206, may transmit a reference signal associated with a resource while applying one or multiple of a transmit power, a beam, and a timing alignment mode associated with a downstream communication of Node1 1206. Then, a gNB 1204 or an IAB node/donor receiving the reference signal from Node1 1206 may measure a signal strength of the reference signal. The measurement result may then be used to manage interference, for example, by using the result for scheduling, power control, beam management, link adaptation, and so on. Alternatively, the measured signal strength may be reported to another node, such as a parent node, such that it can perform scheduling, power control, beam management, link adaptation, and so on. The node performing the measurement or receiving the measurement report may be a gNB 1204 or an IAB node/donor.

In an embodiment, an IAB donor Node0 1202 configures a resource for an IAB node Node1 1206 as flexible (F) and/or soft(S). Furthermore, Node0 1202 configures a first reference signal, such as a CSI-RS, and a second reference signal, such as an SRS, associated with the flexible resource. Then, if Node1 1206 uses the resource for both DL and UL transmissions, for example in an FDM and/or SDM scheme, Node1 1206 may transmit both the first reference signal and the second reference signal. Node1 1206 may transmit the first reference signal associated with the resource while applying one or multiple of a transmit power, a beam, and a timing alignment mode associated with a DL signal to be transmitted on the resource. Node1 1206 may transmit the second reference signal associated with the resource while applying one or multiple of a transmit power, a beam, and a timing alignment mode associated with a UL signal to be transmitted on the resource. Then, a gNB 1204 or an IAB node/donor receiving either of the reference signals from Node1 1206 may measure a signal strength of the reference signal(s) and use the measurement results for scheduling, power control, beam management, link adaptation, and so on. Alternatively, the measured signal strength(s) may be reported to another node, such as a parent node, such that it can perform scheduling, power control, beam management, link adaptation, and so on. The node performing the measurement or receiving the measurement report may be a gNB 1204 or an IAB node/donor.

The above embodiments may be extended to a set of resources rather than a resource. A resource may be a time resource such as a symbol, a group of symbols in a slot, a slot a mini-slot, and so on. Alternatively, a resource may be a frequency domain such as a PRB, a group of PRBs, a sub-channel, a fraction of a BWP, and so on. By extension, a resource may be in the time-frequency grid indicated by joint or separate messages as described earlier.

In some embodiments, an IAB donor Node0 1202 configures a set of resources for an IAB node Node1 1206, where all or a subset of the resources in the set of resources may be configured as flexible (F) and/or soft(S). Furthermore, Node0 1202 may configure one or both a first reference signal, such as a CSI-RS, and a second reference signal, such as an SRS, associated with the set of resources or a subset of the set of resource. Then, if Node1 1206 uses a resource from the set of the resources or a subset of the set of resources for DL, Node1 1206 may transmit the first reference signal. Similarly, if Node1 1206 uses a resource from the set of the resources or a subset of the set of resources for UL, Node1 1206 may transmit the second reference signal. If Node1 1206 uses a first resource from the set of the resources or a subset of the set of resources for DL, and if Node1 1206 uses a second resource from the set of the resources or a subset of the set of resources for UL, Node1 1206 may transmit both the first reference signal and the second reference signal. This case may include cases of FDM and/or SDM schemes.

In any of the embodiments presented herein, an additional or alternative condition for transmitting a reference signal may be a conditional based on whether a resource or a subset of resources or a set of resources, as described earlier, is indicated available or conditionally available by a control message such as a DCI 2_5.

In the above embodiments, Node1 1206 may transmit the first reference signal while applying one or multiple of a transmit power, a beam, and a timing alignment mode associated with a DL signal to be transmitted on the resources. If Node1 1206 is to transmit multiple DL signals on the resources, it may apply an average transmit power or a maximum transmit power associated with the DL signals. Similarly, Node1 1206 may transmit the second reference signal while applying one or multiple of a transmit power, a beam, and a timing alignment mode associated with a UL signal to be transmitted on the resources. If Node1 1206 is to transmit multiple UL signals on the resources, it may apply an average transmit power or a maximum transmit power associated with the UL signals. This case may include cases of FDM and/or SDM schemes.

If Node1 1206 is to transmit multiple DL and UL signals on the resources, for example in an FDM and/or SDM scheme, it may apply an average transmit power or a maximum transmit power associated with the DL and UL signals subject to constraints such as a maximum power constraint, a beam constraint, a timing alignment mode constraint, and so on. This case may include cases of FDM and/or SDM schemes.

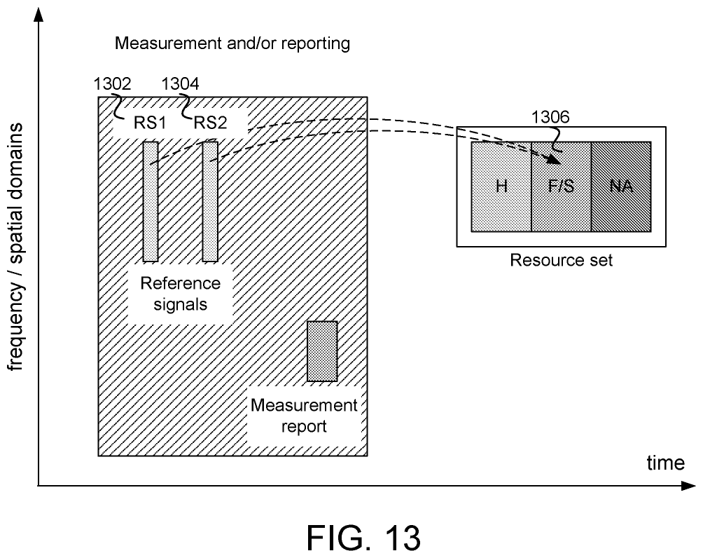

FIG. 13 shows an example timeline and associations between reference signals and flexible resources in a resource set as configured by an IAB-CU.

In this example, a first reference signal RS1 1302 is associated with the flexible (F) and/or soft(S) resources 1306 in the resource set for the DL direction, while a second reference signal RS2 1304 is associated with the flexible (F) and/or soft(S) resources 1306 in the resource configuration for the UL direction. In this example, RS1 1302 may be a downlink reference signal, such as a CSI-RS or an SS/PBCH, and RS2 1304 may be an uplink reference signal, such as an SRS. The resource configuration may be in time and/or frequency domains and may span one or multiple symbols or slots in the time domain and one or multiple PRBs in the frequency domain.

Any of the methods presented herein for TDM, FDM, and SDM may be specified by the standard and/or configured by the network such that the receiver can expect reference signal transmissions unambiguously.

Similar methods may be used to indicate a transmission on a soft resource instead of, or in addition to, indicating a direction of a transmission (DL, UL, etc.).

In some embodiments, referring to FIG. 12, Node0 1202 sends an information element (IE) containing information of a reference signal, such as a synchronization signal, a CSI-RS, an SRS, a reference signal for measuring cross-link interference, or a like, and an indication that associates the reference signal with availability or conditional availability of soft resources.

In an embodiment, an IAB donor Node0 1202 configures a resource for an IAB node Node1 1206 as soft(S). Furthermore, Node0 1202 configures a reference signal associated with the soft resource. Then, if the resource is indicated as available or conditionally available by a parent node of Node1 1206, Node1 1206 transmits the reference signal; otherwise, if the resource is not indicated as available or conditionally available by a parent node of Node1 12060, Node1 1206 does not transmit the reference signal. In this and any of the embodiments presented herein, transmission of a reference signal associated with a soft resource may be performed based on an alternative or an additional condition that the resource is used, e.g., upon being indicated available or conditionally available, based on a short-term (operation) condition and/or a long-term (hardware, firmware, software) capability.

In the above embodiment, if the soft resource is configured as DL, the reference signal may be a downlink reference signal such as a CSI-RS, a PSS, an SSS, an SS/PBCH block, or a like. If the soft resource is configured as UL, the reference signal may be an uplink reference signal such as an SRS.

In the above embodiments, if the soft resource is configured as flexible (F) and/or soft(S) 1306, a first reference signal 1302 may be a downlink reference signal such as a CSI-RS, a PSS, an SSS, an SS/PBCH block, or a like, and a second reference signal 1304 may be an uplink reference signal such as an SRS. Then, if the resource is indicated as available for DL, Node1 1206 may transmit the first reference signal 1302; otherwise, if the resource is indicated as available for UL, Node1 1206 may transmit the second reference signal; otherwise, if the resource is indicated as available for DL and UL, Node1 1206 may transmit both the first reference signal 1302 and the second reference signal 1304; otherwise, if the resource is indicated as not available for DL and UL, Node1 1206 may transmit neither of the reference signals.

Furthermore, in the above embodiments, Node1 1206 may transmit a reference signal associated with a resource while applying one or multiple of a transmit power, a beam, and a timing alignment mode associated with the resource. Then, a gNB 1204 or an IAB node/donor receiving the reference signal from Node1 1206 may measure a signal strength of the reference signal. The measurement result may then be used to manage interference, for example, by using the result for scheduling, power control, beam management, link adaptation, and so on. Alternatively, the measured signal strength may be reported to another node, such as a parent node, such that it can perform scheduling, power control, beam management, link adaptation, and so on. The node performing the measurement or receiving the measurement report may be a gNB 1204 or an IAB node/donor.

The above embodiments may be extended to a plurality of resources rather than a resource.

In some embodiments, an IAB donor Node0 1202 configures a set of resources for an IAB node Node1 1206, where all or a subset of the resources in the set of resources may be configured as soft(S). Furthermore, Node0 1202 may configure one or both a first reference signal 1302, such as a CSI-RS, and a second reference signal 1304, such as an SRS, associated with the set of resources or a subset of the set of resource. Then, if a resource from the set of the resources or a subset of the set of resources is indicated available or conditionally available for DL, Node1 1206 may transmit the first reference signal 1302. Similarly, if a resource from the set of the resources or a subset of the set of resources is indicated available or conditionally available for UL, a child node or UE 1210 served by Node1 1206 may transmit the second reference signal 1304. If Node1 1206 uses a first resource from the set of the resources or a subset of the set of resources for DL, and if Node1 1206 uses a second resource from the set of the resources or a subset of the set of resources for UL, Node1 1206 and child/UE 1210 served by Node1 1206 may transmit the first reference signal 1302 and the second reference signal 1304, respectively. This case may include cases of FDM and/or SDM schemes.

In the above embodiments, Node1 1206 may transmit the first reference signal 1302 while applying one or multiple of a transmit power, a beam, and a timing alignment mode associated with a DL signal to be transmitted on the resources. If Node1 1206 is to transmit multiple DL signals on the resources, it may apply an average transmit power or a maximum transmit power associated with the DL signals. Similarly, a child node or a UE 1210 served by Node1 1206 may transmit the second reference signal 1304 while applying one or multiple of a transmit power, a beam, and a timing alignment mode associated with a UL signal to be transmitted on the resources. If one or multiple child nodes or UEs 1210 served by Node1 1206 are to transmit multiple UL signals on the resources, they may apply an average transmit power or a maximum transmit power associated with the UL signals. This case may include cases of FDM and/or SDM schemes.

If Node1 1206, and/or a child node or UE 1210 served by Node1 1206, is to transmit multiple DL and UL signals on the resources, for example in an FDM and/or SDM scheme, it may apply an average transmit power or a maximum transmit power associated with the DL and UL signals subject to constraints such as a maximum power constraint, a beam constraint, a timing alignment mode constraint, and so on. This case may include cases of FDM and/or SDM schemes.

Embodiments of the methods proposed thus far were described for IAB-to-gNB scenarios, e.g., where the aggressor is an IAB system 1201 and the victim is a gNB 1204. The methods can be extended to IAB-to-IAB scenarios where the victim is another IAB system 1201. Indeed, two or more IAB systems 1201 may communicate on an Xn interface 1212 based on the methods proposed in this disclosure for interference coordination purposes.

Although each IAB system 1201 or IAB node 1206 may be an aggressor and a victim for an instance of interference, it may be assumed that one IAB system 1201 is the aggressor and one IAB system 1201 is the victim for each signaling instance. Therefore, for the following embodiments, consider the scenario (not shown) where a first IAB system, dubbed IAB1 and configured by IAB-CU1 in IAB donor 1, is the aggressor and second IAB system, dubbed IAB2 and configured by IAB-CU2 in IAB donor 2, is the victim.

In an embodiment, IAB donor 1 sends an IE to IAB donor 2 as proposed in the previous embodiments. Then, IAB donor 2 receives the IE and distributes the information to all the IAB nodes configured and served by the IAB donor 2 over an F1 interface.

Alternatively, once IAB donor 2 receives the IE from IAB donor 1, it may process the information and send is selectively to the IAB nodes.

In an alternative embodiment, IAB donor 1 sends information of resource configurations and reference signals. Then, IAB donor 2 may send the information selectively to IAB nodes such that only information of IAB nodes from IAB1 that are in a vicinity of an IAB node from IAB2 are sent to the IAB node. For example, if IAB1 comprises IAB nodes Node1 and Node2 and IAB2 comprises an IAB node Node3, and if the interference from Node1 on Node3 is strong, but the interference from Node2 on Node3 is not strong, IAB donor 2 may send configuration and RS information associated with Node1 to IAB node Node3, but not configuration and RS information associated with Node2 to IAB node Node3.

In one embodiment, IAB donor 2 may decide on what information to send to which IAB node based on a geographical distance between an aggressor IAB node from IAB1 and a victim IAB node in IAB2. For this embodiment, location information of Node3 may be collected by IAB donor 2, while location information of Node1 and Node2 may be collected by IAB donor 1 and sent to IAB donor 2. A value of maximum distance between an aggressor and a victim may also be configured for IAB donor 2. Then, IAB donor 2 may send configuration and RS information associated with Node1 to Node3 if the distance between Node1 and Node3 is not larger than the value of maximum distance.

In another embodiment, IAB donor 2 may initially send information associated to both Node1 and Node2 to Node3. Then, Node3 may inform IAB-CU2 that the interference from Node1 is larger than a threshold while the interference from Node2 is smaller than a threshold. Then, realizing that Node3 does not seek to get updated information about Node3, IAB donor 2 may only send information associated with Node1 to Node2 in the next iterations.

In yet another embodiment, the information that IAB donor 1 sends to IAB donor 2 may not comprise information of IAB nodes, but instead, information of resource configurations and associated RSs. Then, IAB donor 2 may distribute information of configurations and RSs among IAB nodes of IAB2 based on a level of interference one the resources associated with the configuration as measured on the associated RSs.

Methods are proposed in the present disclosure to allocate and manage resources in time and frequency domains. Particularly, some embodiments aim at extending resource allocation and management mechanisms specified for IAB systems in Rel-16 from the time domain to the frequency domain.

In a general wireless system, communications may be multiplexed in other domains such as code and spatial domains. NR systems operating at higher frequency bands such as frequency range 2 (“FR2”) may rely on beamforming, also known as spatial filtering, for directing signals to specific directions (TX beamforming) or amplifying signals received from specific directions (RX beamforming). Beamforming may be in the analog domain, e.g., performed by an RF/analog beamformer, hence presenting the signal transmitted to or received from a direction as a separate resource in the spatial domain. In practice, beamforming may not split the spatial domain into perfectly orthogonal parts, but nevertheless, it may provide a means to multiplex signals with sufficiently low cross-interference.

Therefore, methods proposed in this disclosure may be extended to the spatial domain. That is, any of the methods proposed for the frequency domain may be applied to the spatial domain separately or jointly with mechanisms for allocating and managing time and/or frequency resources.

In some embodiments, a configuration of a resource may comprise spatial information such as a QCL Type D with a reference signal. Then, any attribute such as D/U/F or H/S/NA assigned to the resource may apply to a signal when transmitted or received by a spatial filter through which the reference signal is transmitted or received, respectively.

In some embodiments, a control signaling such as an availability indication (AI) or a conditional availability indication (CAI) associated with a resource may comprise an indication (explicitly in the control signaling or by a prior configuration for signaling) spatial information such as a QCL Type D with a reference signal. Then, any attribute such as D/U/F or an AI/CAI assigned to or indicated for the resource may apply to a signal when transmitted or received by a spatial filter through which the reference signal is transmitted or received, respectively.

In the description of the embodiments in the present disclosure, frequent references are made to how an enhanced duplexing may be indicated to an adjacent node such as a parent node or a child node.

Normally, it is expected that an IAB-CU configuring an IAB can be made aware of capabilities of IAB nodes in the system through RRC messages sent on an F1 interface. Those may include capabilities related to enhanced duplexing and simultaneous operations. Examples of such capabilities are a number of antenna panels, a number of antenna panels for upstream, a number of antenna panels for downstream, a beamforming capability, an FDM/SDM capability, a number of DFT/IDFT windows, and so on. This information may be required or helpful for the IAB-CU to configure resources properly for the IAB nodes. The IAB-CU may further be informed of topological changes in the IAB system, mobility of IAB nodes, changes in a large-scale interference level, and so on, based on which the IAB-CU may change resource configurations.

Subsequently, the IAB-CU may inform IAB nodes of capabilities associated with other IAB nodes such as a parent node of child node. The communications may occur on an F1 interface and in the form of RRC configuration IEs.

However, RRC signaling over an F1 interface may not be sufficient for short-scale changes in the capability of an IAB node to perform simultaneous operation, especially in a multi-hop IAB system where communicating RRC messages from an IAB node to the IAB-CU and then from the IAB-CU to another node may cause a significant delay. Therefore, direct control signaling between IAB nodes may be adopted in order to inform other nodes of an instantaneous ability of an IAB node to perform simultaneous operations.

In some embodiments, an L1/L2 control message from an IAB node to a parent node serving the IAB node or a child node served by the IAB node may inform the parent/child node of the IAB node's ability to perform a simultaneous operation. This “short-scale” capability indication may be determined by a hardware capability such as a number of antenna panels, a power constraint, an interference constraint, a beamforming/spatial constraint, a timing alignment constraint, or a like.

In a simple embodiment, the control message may carry one bit of information indicating whether the IAB node is capable of performing simultaneous operation at the present time.

In another embodiment, the control message may further indicate whether it can perform a simultaneous operation based on a beamforming/spatial constraint, a power constraint, an interference constraint, a timing constraint, and so on. Particularly, the IAB node may be able to perform a simultaneous operation based on a spatial filter, a TX/RX power range, an interference threshold, or a timing alignment scheme at one time, but it may be unable to do so at another time.

In yet another embodiment, the control message may comprise information of the type of simultaneous operation the IAB node is capable of. For example, the IAB node may be able to perform half-duplex simultaneous TX or simultaneous RX, but it may be unable to perform a full-duplex operation based on a hardware capability or an operation constraint (spatial, power, interference, timing, etc.).

In an embodiment, the control message may be periodic. In another embodiment, the control message may be transmitted upon demand, for example in response to a soliciting control signaling or only when the IAB node is temporarily deviating from a capability it has indicated earlier, e.g., due an operation constraint.

Another concept that may be introduced to the methods proposed in this disclosure is simultaneous based on “best effort.” It was mentioned earlier that despite an IAB node's capability to perform simultaneous operation, the capability may be disrupted temporarily due to a constraint during the operation. In this case, a best-effort approach may be taken by the IAB system or an IAB node to perform simultaneous operations only when they are possible.

For example, an IAB node may be configured or indicated to use a time-frequency resource in a direction, for example for a DL or UL communication. Then, the IAB node may use the resource in the configured/indicated direction. Additionally, if the IAB node is capable of performing an upstream or downstream communication simultaneously based on its hardware capabilities and while considering operation constraints, the IAB node may choose to schedule a communication and/or indicate to an adjacent node to expect a communication on the resource or a time-overlapping (“TOL”) resource.

An IAB node performing simultaneous operations based on a best-effort approach may still inform adjacent nodes, either a parent/child node or a node in a physical vicinity, of its intention to perform a communication other than one configured or indicated to the IAB nodes. This control signaling may inform the adjacent node(s) of upcoming communications and may allow them to take an action accordingly, for example to perform beamforming or mitigate interference.

In an embodiment, an IAB node may perform a simultaneous operation based on a best-effort approach only on certain symbols. The symbols may be configured or indicated to be usable for simultaneous operation based on a best-effort approach.

Specifically, in some embodiments, only resources configured or indicated flexible (F) may be used for a simultaneous operation based on a best-effort approach.

In some embodiments, a new type of resource may be introduced to allow an IAB node to perform simultaneous operation, either based on a nest-effort method or otherwise. This type of resource may be called DL+UL, which may or may not be interpreted as a flexible (F) symbol.

In some embodiments, a DL+UL symbol may be realized by introducing a new value in addition to DL, UL, and F. this may require altering the structure of currently specified messages.

In some embodiments, a DL+UL symbol may be realized by separate signaling. An example of the separate signaling is the TDD-UL-DL-ConfigDedicated2-r17 IE as proposed in several embodiments of this disclosure. A similar principle may be adopted to introduce control messages with structures similar to that of SFI, for example.

### Notes and Terminology

The following signaling mechanisms in NR allow to communicate DL/UL information of an OFDM symbol to a UE:
a. Semi-static RRC signaling,
b. Dynamic slot format indication (SFI) shared by a group of UEs,
c. Dynamic signaling to schedule a channel for a UE.

In the descriptions, configurations or signaling for an IAB-MT or an IAB-DU are mentioned.
a. In the case of an IAB-MT, the configuration or signaling may be received by the IAB node from an IAB-CU or a parent node serving the IAB node. For example, when the description reads “an IAB-MT is configured by a resource configuration,” it means the IAB node comprising the IAB-MT has received the resource configuration for the IAB-MT.
b. Similarly, in the case of an IAB-DU, the configuration or signaling may be received by the IAB node from an IAB-CU or a parent node serving the IAB node. Alternatively, the configuration or signaling may be received by a child node served by the IAB-DU, in which case the IAB-DU may also be informed of the configuration or signaling to the child node. For example, when the description reads “an IAB-DU is configured by a resource e configuration,” it may mean a child node (or a UE or an enhanced UE) served by the IAB-DU has received the resource configuration, in which case the IAB node comprising the IAB-DU may also be informed of the resource configuration.

In each of the above cases, a configuration or signaling may be received from an IAB-CU on an F1 interface. In each of the above cases, a control signaling may be received from a parent node or a child node on a physical control channel or by a MAC message.

In each embodiment, SDM may refer to a scenario where same frequency resources are used for multiple operations that are multiplexed in the spatial domain, e.g., by multiple antenna panels and/or multiple beams. In each embodiment, FDM may refer to a scenario where different frequency resources are used for multiple operations that may or may not be multiplexed in a spatial domain. The focus of these embodiments is reusing time resources, although TDM is not precluded, possibly in combination of SDM and/or FDM. As such, combination of SDM and FDM and possible combination with other multiplexing schemes such as CDM is not precluded.

In some embodiments, SDM may refer multi-panel operation where multiple antennas, antenna panels, antenna ports, etc. may be used for multiplexing communications.

Resource configurations may comprise TDD-UL-DL-ConfigCommon and TDD-UL-DL-ConfigDedicated as well as TDD-UL-DL-ConfigDedicated-IAB-MT-r16. Furthermore, new RRC IEs may be used as proposed in [5], which may be called TDD-UL-DL-ConfigDedicated2-r17 or TDD-UL-DL-ConfigDedicated2-LAB-MT-r17, for example.

In this disclosure, reference is frequently made to time-overlapping (“TOL”) resources such as TOL symbols, although the standard specification may use a different term for overlapping resources or simply refer to “same” resources. One reason for this definition is to clarify that TOL resources may be defined or configured for different entities, such as different IAB nodes, an IAB-MT and IAB-DU of an IAB node, and so on. Another reason is to cover cases with different numerologies where a symbol in a first operation/configuration may not have the same length in time as a symbol in a second operation/configuration. Yet another reason is to cover cases that a timing misalignment, whether deliberate due to employing different timing alignments or due to an error. TOL resources will be described later in the next sections.

It should be noted that TOL as a relationship between two resources is commutative—if a first resource/symbol A is time-overlapping with a second resource/symbol B, then B is also TOL with A. Description of the embodiments often make references to a symbol in a first operation/configuration and a TOL symbol in a second operation/configuration.

In the descriptions of embodiments in this disclosure, an “operation” may refer to a transmission (TX) of a signal or a reception (RX) of signal. In this context, a simultaneous operation may refer to simultaneous transmissions, simultaneous receptions, or simultaneous transmissions and receptions by two communication entities. In preferred embodiments, the two entities may belong to a same node such as an IAB node. in preferred embodiments, the two entities may be an IAB-MT and an IAB-DU of an IAB node.

Finally, although embodiments are described for symbols, such as OFDM symbols, as a unit of time resources, the methods can be extended to other units such as slots, mini-slots, subframes, a group of symbols such as all the DL, UL, or F symbols in a slot or a group of slots, and so on. Furthermore, the methods may be extended to the frequency domain (with a unit of resource element, resource block, sub-channel, etc.) or other domains.

For Case A duplexing, which is simultaneous IAB-MT TX (UL) and IAB-DU TX (DL), the following may be applicable:
a. Simultaneous TX capability: This may refer to an IAB node's capability to perform simultaneous transmissions, which may indicate that the IAB node is capable of SDM and/or FDM, the IAB node has multiple antenna panels (SDM), the IAB node is capable of simultaneous transmissions in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.
b. Power imbalance constraint: This may refer to a constraint according to which the difference between a TX powers for an IAB-MT TX and an IAB-DU TX is not larger than a threshold. The threshold may be determined by an IAB node capability that specifies a maximum power imbalance on one panel (FDM) or among multiple panels (SDM). In the case of configuration-based methods, a power imbalance constraint may be satisfied by semi-static configuration of TX powers. In the case of methods based on control signaling, a TX power for an IAB-MT TX may be determined by a parent node serving the IAB-MT. Therefore, a power imbalance constraint may require an IAB node to adjust a TX power for an IAB-DU TX, if possible, or decline a transmission otherwise.
c. Total power constraint: this may refer to a constraint according to which the total TX power for an IAB-MT TX and an IAB-DU TX does not exceed a threshold. The threshold may be determined by an IAB node capability that specifies a maximum total power for a panel (FDM) or for the IAB node (SDM), by a regulatory limit, or a like. In the case of configuration-based methods, a total power constraint may be satisfied by semi-static configuration of TX powers. In the case of methods based on control signaling, a TX power for an IAB-MT TX may be determined by a parent node serving the IAB-MT. Therefore, a total power constraint may require an IAB node to adjust a TX power for an IAB-DU TX, if possible, or decline a transmission otherwise.
d. Interference constraint: This may refer to a variety of interference constraints between antennas of an IAB node (self-interference), interference on other nodes or channels or cells, and so on. In some embodiments, according to an interference constraint, the interference by an IAB-DU TX on a parent node should be below a threshold when the parent node performs beamforming for receiving a signal from the IAB-MT. In some embodiments, according to an interference constraint, the interference by the IAB-MT TX on a child node should be below a threshold when the child node performs beamforming for receiving a signal from the IAB-DU.
e. Guard band constraint: This may refer to a constraint according to which the frequency resources (e.g., PRBs) allocated to the IAB-MT is separated from the frequency resources allocated to the IAB-DU by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.
f. Spatial constraint (FDM): This may refer to a constraint according to which a beam (spatial filter) for transmitting a signal is constrained by a beam (spatial filter) for transmitting another signal. A common case for this constraint is when one or multiple antenna panels are controlled by a same circuitry for controlling beamforming. In this case, if the one or multiple panels are beamformed to transmit a first signal in a particular direction in the spatial domain, any second signal may be constrained to be transmitted with a same beamforming configuration if the same one or multiple panels is to be used. Whether a spatial constraint applies to an IAB node or an antenna panel of an IAB node may be determined by a capability of the IAB node, which may be communicated to an IAB-CU (in the case of configuration-based methods) or another IAB node such as a parent node or a child node (in the case of methods based on control signaling).
g. Timing alignment constraint (FDM): This constraint may be applicable if the antenna panel is connected to a baseband processor with one DFT/IDFT window. In this case, the timing for an IAB-MT TX and an IAB-DU TX should be aligned at least at a symbol level. The timing alignment may correspond to a Case-6 timing scheme as specified by the standard, configured by the network, signaled by a parent node, and so on.

For Case B duplexing, which is simultaneous IAB-MT RX (DL) and IAB-DU RX (UL), the following may be applicable:
a. Simultaneous RX capability: This may refer to an IAB node's capability to perform simultaneous receptions, which may indicate that the IAB node is capable of SDM and/or FDM, the IAB node has multiple antenna panels (SDM), the IAB node is capable of simultaneous receptions in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.
b. Power imbalance constraint: This may refer to a constraint according to which the difference between RX powers for an IAB-MT RX and an IAB-DU RX is not larger than a threshold. The threshold may be determined by an IAB node capability that specifies a maximum power imbalance on one panel (FDM) or among multiple panels (SDM). In the case of configuration-based methods, a power imbalance constraint may be satisfied by semi-static configuration of TX powers. In the case of methods based on control signaling, a TX power for a child node TX may be determined by an IAB-DU serving the child node. Therefore, a power imbalance constraint may require a parent node to adjust a TX power for a parent node TX, if possible, or decline a transmission otherwise. Alternatively, an IAB-DU may need to signal a child node to adjust its TX power in order to satisfy a power imbalance constraint while the RX power from a parent node serving an IAB-MT is determined or known by the IAB node.
c. Interference constraint: This may refer to a variety of interference constraints between antennas of an IAB node (self-interference), interference on other nodes or channels or cells, and so on. In some embodiments, according to an interference constraint, the interference by a child node on an IAB-MT RX should be below a threshold when the IAB-MT performs beamforming for receiving a signal from a parent node. In some embodiments, according to an interference constraint, the interference by a parent node on an IAB-DU RX should be below a threshold when the IAB-DU performs beamforming for receiving a signal from a child node.
d. Guard band constraint: This may refer to a constraint according to which the frequency resources (e.g., PRBs) allocated to the IAB-MT is separated from the frequency resources allocated to the IAB-DU by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.
e. Spatial constraint (FDM): This may refer to a constraint according to which a beam (spatial filter) for receiving a signal is constrained by a beam (spatial filter) for receiving another signal. A common case for this constraint is when one or multiple antenna panels are controlled by a same circuitry for controlling beamforming. In this case, if the one or multiple panels are beamformed to receive a first signal in a particular direction in the spatial domain, any second signal may be constrained to be received with a same beamforming configuration if the same one or multiple panels is to be used. Whether a spatial constraint applies to an IAB node or an antenna panel of an IAB node may be determined by a capability of the IAB node, which may be communicated to an IAB-CU (in the case of configuration-based methods) or another IAB node such as a parent node or a child node (in the case of methods based on control signaling).
f. Timing alignment constraint (FDM): This constraint may be applicable if the antenna panel is connected to a baseband processor with one DFT/IDFT window. In this case, the timing for an IAB-MT RX and an IAB-DU RX should be aligned at least at a symbol level. The timing alignment may correspond to a Case-7 timing scheme as specified by the standard, configured by the network, signaled by a parent node, and so on.

For Case C duplexing, which is simultaneous IAB-MT TX (UL) and IAB-DU RX (UL), and Case D duplexing, which is simultaneous IAB-MT RX (DL) and IAB-DU TX (DL), the following may be applicable:
a. Simultaneous TX/RX capability: This may refer to an IAB node's capability to perform simultaneous transmission and reception, which may indicate that the IAB node is capable of SDM and/or FDM, the IAB node has multiple antenna panels (SDM), the IAB node is capable of simultaneous transmission and reception in DL and UL, the IAB node is capable of enhanced duplexing, or a like. In the case of configuration-based methods, information of the capability may be sent to an IAB-CU that configures the system. In the case of methods based on control signaling, the information of the capability may be sent to another IAB node such as a parent node or a child node.
b. Interference constraint: This may refer to a variety of interference constraints between antennas of an IAB node (self-interference), interference on other nodes or channels or cells, and so on. In some embodiments, according to an interference constraint, the interference by a child node on a parent node RX should be below a threshold when the parent node performs beamforming for receiving a signal from an IAB-MT. For Case C, according to an interference constraint, the interference by an IAB-MT on an IAB-DU RX should be below a threshold when the IAB-DU performs beamforming for receiving a signal from a child node. For Case D, according to an interference constraint, the interference by an IAB-DU on an IAB-MT RX should be below a threshold when the IAB-MT performs beamforming for receiving a signal from a parent node.
c. Guard band constraint: This may refer to a constraint according to which the frequency resources (e.g., PRBs) allocated to the IAB-MT is separated from the frequency resources allocated to the IAB-DU by at least a threshold called a guard band. A value of the guard band may be determined by an IAB node capability for one panel (FDM) or among multiple panels (SDM). In the case of configuration-based methods, a resource may be allocated by a configuration. In the case of methods based on control signaling, a resource may be allocated by control message such as an L1/L2 message.

In some embodiments, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHZ, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices such as a CU, it can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported/used for transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, i.e. the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between an IAB-DU of a parent IAB node and an IAB-MT of a child IAB node). In some of the embodiments described, a TCI state comprises at least one source RS to provide a reference (device assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

The following should be noted throughout the present disclosure:

Although the entities are referred to as IAB nodes, the same methods can be applied to IAB donors, which are the IAB entities connecting the core network to the IAB network, with minimum or zero modifications.

The different steps described for the example embodiments, in the text and in the flowcharts, may be permuted.

Each configuration may be provided by one or multiple configurations in practice. An earlier configuration may provide a subset of parameters while a later configuration may provide another subset of parameters. Alternatively, a later configuration may override values provided by an earlier configuration or a pre-configuration.

A configuration may be provided by a radio resource control (“RRC”) signaling, a medium-access control (“MAC”) signaling, a physical layer signaling such as a downlink control information (“DCI”) message, a combination thereof, or other methods. A configuration may include a pre-configuration, or a semi-static configuration provided by the standard, by the vendor, and/or by the network/operator. Each parameter value received through configuration or indication may override previous values for a similar parameter.

Despite frequent references to IAB, the proposed solutions may be applicable to wireless relay nodes and other types of wireless communication entities.

L1/L2 control signaling may refer to control signaling in layer 1 (physical layer) or layer 2 (data link layer). Particularly, an L1/L2 control signaling may refer to an L1 control signaling such as a DCI message or a UCI message, an L2 control signaling such as a MAC message, or a combination thereof. A format and an interpretation of an L1/L2 control signaling may be determined by the standard, a configuration, other control signaling, or a combination thereof.

Any parameter discussed in this disclosure may appear, in practice, as a linear function of that parameter in signaling or specifications.

In any timing assignment for a slot that contains a signal, a timing assignment in the text or in an equation by a sign such as ‘=’ or ‘: =’ or a like may mean that the start time of the slot containing the signal is equal to a determined value such as a right hand side of the equation. Alternatively, the start time of the slot containing the signal may be different from the determined value by an integer multiple of T_“slot”, where T_“slot” denotes a slot duration for a given numerology or subcarrier spacing (SCS). This is, in general, applicable to all timing assignments in the present disclosure. In some embodiment, the said values may be different by an integer multiple of T_“symbol” rather than an integer multiple of T_“slot”, where T_“symbol” denotes a symbol duration for a given numerology or subcarrier spacing (SCS).

It was discussed in 3GPP RAN to allow a vendor manufacturing IAB systems/devices and an operator deploying the IAB systems/devices to negotiate capabilities of the systems/devices. This means that some of the information assumed to need signaling between entities may readily be available to the devices, for example, by storing the information on a memory unit such as a read-only memory (ROM), exchanging the information by proprietary signaling methods, providing the information by a (pre) configuration, or otherwise taking the information into account when creating hardware and/or software of the IAB systems/devices or other entities in the network. In this case, methods described in this disclosure that comprise exchanging the information can be extended to similar methods wherein the information is obtained by those said other methods.

Methods and systems proposed for an IAB-MT may be adopted by a UE as well. If a method or system requires a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

In this disclosure, a node or a wireless node may refer to an IAB node, an IAB-DU, an IAB-MT, a UE, a base station (BS) or a gNodeB (gNB) or a transmit-receive point (TRP) or an IAB donor, and so on. The examples embodiments provided with an emphasis on the type of nodes are not meant to limit the scope of the invention.

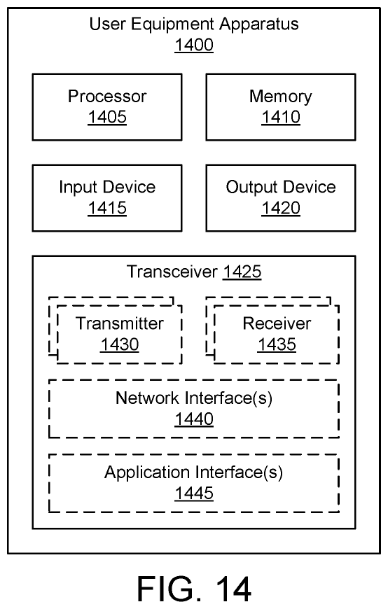

FIG. 14 depicts a user equipment apparatus 1400 that may be used for soft resource management in integrated access and backhaul may be used, according to embodiments of the disclosure. In various embodiments, the user equipment apparatus 1400 is used to implement one or more of the solutions described above. The user equipment apparatus 1400 may be one embodiment of the remote unit 105 and/or the UE 205, described above. Furthermore, the user equipment apparatus 1400 may include a processor 1405, a memory 1410, an input device 1415, an output device 1420, and a transceiver 1425.

In some embodiments, the input device 1415 and the output device 1420 are combined into a single device, such as a touchscreen. In certain embodiments, the user equipment apparatus 1400 may not include any input device 1415 and/or output device 1420. In various embodiments, the user equipment apparatus 1400 may include one or more of: the processor 1405, the memory 1410, and the transceiver 1425, and may not include the input device 1415 and/or the output device 1420.

As depicted, the transceiver 1425 includes at least one transmitter 1430 and at least one receiver 1435. In some embodiments, the transceiver 1425 communicates with one or more cells (or wireless coverage areas) supported by one or more base units 121. In various embodiments, the transceiver 1425 is operable on unlicensed spectrum. Moreover, the transceiver 1425 may include multiple UE panel supporting one or more beams. Additionally, the transceiver 1425 may support at least one network interface 1440 and/or application interface 1445. The application interface(s) 1445 may support one or more APIs. The network interface(s) 1440 may support 3GPP reference points, such as Uu, N1, PC5, etc. Other network interfaces 1440 may be supported, as understood by one of ordinary skill in the art.

The processor 1405, in one embodiment, may include any known controller capable of executing computer-readable instructions and/or capable of performing logical operations. For example, the processor 1405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1405 executes instructions stored in the memory 1410 to perform the methods and routines described herein. The processor 1405 is communicatively coupled to the memory 1410, the input device 1415, the output device 1420, and the transceiver 1425. In certain embodiments, the processor 1405 may include an application processor (also known as “main processor”) which manages application-domain and operating system (“OS”) functions and a baseband processor (also known as “baseband radio processor”) which manages radio functions.

In various embodiments, the processor 1405 and transceiver 1425 control the user equipment apparatus 1400 to implement the above described UE behaviors. For example, the transceiver 1425 receives configurations for a plurality of resource block groups, the configurations comprising an indication that the plurality of resource block groups is soft and an availability combination associated with the plurality of resource block groups. In one embodiment, the transceiver 1425 receives an availability indication control message associated with the availability combination, the availability indication control message comprising an availability indication field associated with the plurality of resource block groups. In one embodiment, the processor 1405 determines that physical resource blocks in the plurality of resource block groups in a plurality of physical resource block groups are available in response to the availability indication field being equal to ‘1’ and unavailable in response to the availability indication field being equal to ‘0’.

In one embodiment, the transceiver 1425 receives configurations for a plurality of physical resource blocks in a frequency domain and configurations for the plurality of resource block groups, each resource block group comprising a first number of physical resource blocks.

In one embodiment, the availability indication field is a bit in a bitmap of the availability indication control message.

In one embodiment, the availability indication control message is a downlink control information message.

In one embodiment, the transceiver 1425 receives a first control message indicating that a first resource is conditionally available by a first entity, the first resource comprising a soft resource and the processor 1405 performs a downlink transmission by the first resource in response to determining that the downlink transmission does not change an uplink transmission on a second resource at a second entity, the second resource overlapping the first resource in a time domain and omits a downlink transmission on the first resource in response to determining that the downlink transmission changes an uplink transmission on the second resource at the second entity, the second resource overlapping the first resource in a time domain.

In one embodiment, the transceiver 1425 transmits a second control message to a second network node, the second network node comprising a serving node of the network node, the second control message indicating whether the downlink transmission was omitted.

In one embodiment, the transceiver 1425 transmits a message to a third network node, the third network node comprising a configuration entity, the message indicating whether the downlink transmission was omitted.

In one embodiment, the configuration entity is a central unit that transmits configurations to the UE device.

In one embodiment, the network node is an integrated access and backhaul node, the first entity is a distributed unit, and the second entity is a mobile terminal.

In one embodiment, the determining is based at least in part on one or more of a multiplexing capability of the network node, a duplexing capability of the network node, a capability of time-domain multiplexing between the first entity and the second entity, and a number of antenna panels of the network node.

In one embodiment, the determining is based at least in part on one or more of a beamforming constraint, a power imbalance constraint, a total power constraint, an interference constraint, and a timing alignment constraint.

In one embodiment, the transceiver 1425 transmits, over an F1 interface and an Xn interface, a configuration comprising information indicating a set of soft resource blocks and receives, over the F1 interface, at least one of the availability indication control message and at least one conditional availability indication message associated with at least one soft resource block in the set of soft resource blocks. In one embodiment, the processor 1405 computes an availability indication parameter as a function of at least one of the availability indication message and at least one conditional availability indication message. In one embodiment, the transceiver 1425 transmits, over the Xn interface, an information element comprising the availability indication parameter.

In one embodiment, the function is at least one of a field-wise average, a field-wise logical OR function, and a field-wise logical AND function of at least one of the availability indication message and the at least one conditional availability message.

In one embodiment, at least one of the availability indication message and the at least one conditional availability message is associated with at least one integrated access and backhaul node.

In one embodiment, the at least one integrated access and backhaul node receives the configuration over the F1 interface.

In one embodiment, the processor 1405 determines an availability of physical resource blocks in a plurality of resource block groups in a plurality of physical resource block groups. In one embodiment, the transceiver 1425 transmits configurations for a plurality of resource block groups to second network nodes, the configurations comprising an indication that the plurality of resource block groups is soft and an availability combination associated with the plurality of resource block groups and transmits an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

The memory 1410, in one embodiment, is a computer readable storage medium. In some embodiments, the memory 1410 includes volatile computer storage media. For example, the memory 1410 may include a RAM, including dynamic RAM (“DRAM”), synchronous dynamic RAM (“SDRAM”), and/or static RAM (“SRAM”). In some embodiments, the memory 1410 includes non-volatile computer storage media. For example, the memory 1410 may include a hard disk drive, a flash memory, or any other suitable non-volatile computer storage device. In some embodiments, the memory 1410 includes both volatile and non-volatile computer storage media.

In some embodiments, the memory 1410 stores data related to soft resource management in integrated access and backhaul may be used. For example, the memory 1410 may store various parameters, panel/beam configurations, resource assignments, policies, and the like, as described above. In certain embodiments, the memory 1410 also stores program code and related data, such as an operating system or other controller algorithms operating on the user equipment apparatus 1400.

The input device 1415, in one embodiment, may include any known computer input device including a touch panel, a button, a keyboard, a stylus, a microphone, or the like. In some embodiments, the input device 1415 may be integrated with the output device 1420, for example, as a touchscreen or similar touch-sensitive display. In some embodiments, the input device 1415 includes a touchscreen such that text may be input using a virtual keyboard displayed on the touchscreen and/or by handwriting on the touchscreen. In some embodiments, the input device 1415 includes two or more different devices, such as a keyboard and a touch panel.

The output device 1420, in one embodiment, is designed to output visual, audible, and/or haptic signals. In some embodiments, the output device 1420 includes an electronically controllable display or display device capable of outputting visual data to a user. For example, the output device 1420 may include, but is not limited to, an LCD display, an LED display, an OLED display, a projector, or similar display device capable of outputting images, text, or the like to a user. As another, non-limiting, example, the output device 1420 may include a wearable display separate from, but communicatively coupled to, the rest of the user equipment apparatus 1400, such as a smart watch, smart glasses, a heads-up display, or the like. Further, the output device 1420 may be a component of a smart phone, a personal digital assistant, a television, a table computer, a notebook (laptop) computer, a personal computer, a vehicle dashboard, or the like.

In certain embodiments, the output device 1420 includes one or more speakers for producing sound. For example, the output device 1420 may produce an audible alert or notification (e.g., a beep or chime). In some embodiments, the output device 1420 includes one or more haptic devices for producing vibrations, motion, or other haptic feedback. In some embodiments, all or portions of the output device 1420 may be integrated with the input device 1415. For example, the input device 1415 and output device 1420 may form a touchscreen or similar touch-sensitive display. In other embodiments, the output device 1420 may be located near the input device 1415.

The transceiver 1425 communicates with one or more network functions of a mobile communication network via one or more access networks. The transceiver 1425 operates under the control of the processor 1405 to transmit messages, data, and other signals and also to receive messages, data, and other signals. For example, the processor 1405 may selectively activate the transceiver 1425 (or portions thereof) at particular times in order to send and receive messages.

The transceiver 1425 includes at least transmitter 1430 and at least one receiver 1435. One or more transmitters 1430 may be used to provide UL communication signals to a base unit 121, such as the UL transmissions described herein. Similarly, one or more receivers 1435 may be used to receive DL communication signals from the base unit 121, as described herein. Although only one transmitter 1430 and one receiver 1435 are illustrated, the user equipment apparatus 1400 may have any suitable number of transmitters 1430 and receivers 1435. Further, the transmitter(s) 1430 and the receiver(s) 1435 may be any suitable type of transmitters and receivers. In one embodiment, the transceiver 1425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1425, transmitters 1430, and receivers 1435 may be implemented as physically separate components that access a shared hardware resource and/or software resource, such as for example, the network interface 1440.

In various embodiments, one or more transmitters 1430 and/or one or more receivers 1435 may be implemented and/or integrated into a single hardware component, such as a multi-transceiver chip, a system-on-a-chip, an ASIC, or other type of hardware component. In certain embodiments, one or more transmitters 1430 and/or one or more receivers 1435 may be implemented and/or integrated into a multi-chip module. In some embodiments, other components such as the network interface 1440 or other hardware components/circuits may be integrated with any number of transmitters 1430 and/or receivers 1435 into a single chip. In such embodiment, the transmitters 1430 and receivers 1435 may be logically configured as a transceiver 1425 that uses one more common control signals or as modular transmitters 1430 and receivers 1435 implemented in the same hardware chip or in a multi-chip module.

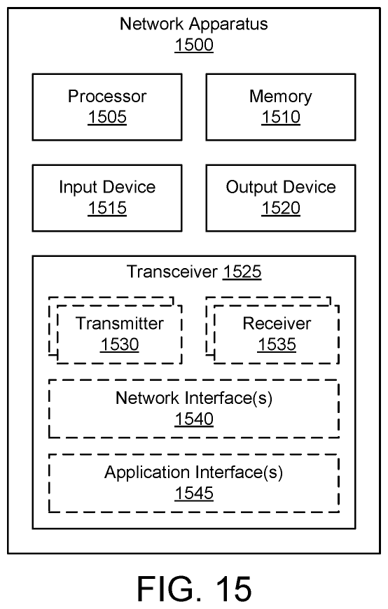

FIG. 15 depicts a network apparatus 1500 that may be used for soft resource management in integrated access and backhaul may be used, according to embodiments of the disclosure. In one embodiment, network apparatus 1500 may be one implementation of a RAN node, such as the base unit 121, the RAN node 210, or gNB, described above. Furthermore, the base network apparatus 1500 may include a processor 1505, a memory 1510, an input device 1515, an output device 1520, and a transceiver 1525.

In some embodiments, the input device 1515 and the output device 1520 are combined into a single device, such as a touchscreen. In certain embodiments, the network apparatus 1500 may not include any input device 1515 and/or output device 1520. In various embodiments, the network apparatus 1500 may include one or more of: the processor 1505, the memory 1510, and the transceiver 1525, and may not include the input device 1515 and/or the output device 1520.

As depicted, the transceiver 1525 includes at least one transmitter 1530 and at least one receiver 1535. Here, the transceiver 1525 communicates with one or more remote units 105. Additionally, the transceiver 1525 may support at least one network interface 1540 and/or application interface 1545. The application interface(s) 1545 may support one or more APIs. The network interface(s) 1540 may support 3GPP reference points, such as Uu, N1, N2 and N3. Other network interfaces 1540 may be supported, as understood by one of ordinary skill in the art.

The processor 1505, in one embodiment, may include any known controller capable of executing computer-readable instructions and/or capable of performing logical operations. For example, the processor 1505 may be a microcontroller, a microprocessor, a CPU, a GPU, an auxiliary processing unit, a FPGA, or similar programmable controller. In some embodiments, the processor 1505 executes instructions stored in the memory 1510 to perform the methods and routines described herein. The processor 1505 is communicatively coupled to the memory 1510, the input device 1515, the output device 1520, and the transceiver 1525. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 1500 is a RAN node (e.g., gNB) that includes a processor 1505 and a transceiver 1525 that receives configurations for a plurality of resource block groups, the configurations comprising an indication that the plurality of resource block groups is soft and an availability combination associated with the plurality of resource block groups. In one embodiment, the transceiver 1525 receives an availability indication control message associated with the availability combination, the availability indication control message comprising an availability indication field associated with the plurality of resource block groups. In one embodiment, the processor 1505 determines that physical resource blocks in the plurality of resource block groups in a plurality of physical resource block groups are available in response to the availability indication field being equal to ‘1’ and unavailable in response to the availability indication field being equal to ‘0’.

In one embodiment, the transceiver 1525 receives configurations for a plurality of physical resource blocks in a frequency domain and configurations for the plurality of resource block groups, each resource block group comprising a first number of physical resource blocks.

In one embodiment, the availability indication field is a bit in a bitmap of the availability indication control message.

In one embodiment, the availability indication control message is a downlink control information message.

In one embodiment, the transceiver 1525 receives a first control message indicating that a first resource is conditionally available by a first entity, the first resource comprising a soft resource and the processor 1505 performs a downlink transmission by the first resource in response to determining that the downlink transmission does not change an uplink transmission on a second resource at a second entity, the second resource overlapping the first resource in a time domain and omits a downlink transmission on the first resource in response to determining that the downlink transmission changes an uplink transmission on the second resource at the second entity, the second resource overlapping the first resource in a time domain.

In one embodiment, the transceiver 1525 transmits a second control message to a second network node, the second network node comprising a serving node of the network node, the second control message indicating whether the downlink transmission was omitted.

In one embodiment, the transceiver 1525 transmits a message to a third network node, the third network node comprising a configuration entity, the message indicating whether the downlink transmission was omitted.

In one embodiment, the configuration entity is a central unit that transmits configurations to the UE device.

In one embodiment, the network node is an integrated access and backhaul node, the first entity is a distributed unit, and the second entity is a mobile terminal.

In one embodiment, the determining is based at least in part on one or more of a multiplexing capability of the network node, a duplexing capability of the network node, a capability of time-domain multiplexing between the first entity and the second entity, and a number of antenna panels of the network node.

In one embodiment, the determining is based at least in part on one or more of a beamforming constraint, a power imbalance constraint, a total power constraint, an interference constraint, and a timing alignment constraint.

In one embodiment, the transceiver 1525 transmits, over an F1 interface and an Xn interface, a configuration comprising information indicating a set of soft resource blocks and receives, over the F1 interface, at least one of the availability indication control message and at least one conditional availability indication message associated with at least one soft resource block in the set of soft resource blocks. In one embodiment, the processor 1505 computes an availability indication parameter as a function of at least one of the availability indication message and at least one conditional availability indication message. In one embodiment, the transceiver 1525 transmits, over the Xn interface, an information element comprising the availability indication parameter.

In one embodiment, the function is at least one of a field-wise average, a field-wise logical OR function, and a field-wise logical AND function of at least one of the availability indication message and the at least one conditional availability message.

In one embodiment, at least one of the availability indication message and the at least one conditional availability message is associated with at least one integrated access and backhaul node.

In one embodiment, the at least one integrated access and backhaul node receives the configuration over the F1 interface.

In one embodiment, the processor 1505 determines an availability of physical resource blocks in a plurality of resource block groups in a plurality of physical resource block groups. In one embodiment, the transceiver 1525 transmits configurations for a plurality of resource block groups to second network nodes, the configurations comprising an indication that the plurality of resource block groups is soft and an availability combination associated with the plurality of resource block groups and transmits an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

The memory 1510, in one embodiment, is a computer readable storage medium. In some embodiments, the memory 1510 includes volatile computer storage media. For example, the memory 1510 may include a RAM, including dynamic RAM (“DRAM”), synchronous dynamic RAM (“SDRAM”), and/or static RAM (“SRAM”). In some embodiments, the memory 1510 includes non-volatile computer storage media. For example, the memory 1510 may include a hard disk drive, a flash memory, or any other suitable non-volatile computer storage device. In some embodiments, the memory 1510 includes both volatile and non-volatile computer storage media.

In some embodiments, the memory 1510 stores data related to soft resource management in integrated access and backhaul may be used. For example, the memory 1510 may store parameters, configurations, resource assignments, policies, and the like, as described above. In certain embodiments, the memory 1510 also stores program code and related data, such as an operating system or other controller algorithms operating on the network apparatus 1500.

The input device 1515, in one embodiment, may include any known computer input device including a touch panel, a button, a keyboard, a stylus, a microphone, or the like. In some embodiments, the input device 1515 may be integrated with the output device 1520, for example, as a touchscreen or similar touch-sensitive display. In some embodiments, the input device 1515 includes a touchscreen such that text may be input using a virtual keyboard displayed on the touchscreen and/or by handwriting on the touchscreen. In some embodiments, the input device 1515 includes two or more different devices, such as a keyboard and a touch panel.

The output device 1520, in one embodiment, is designed to output visual, audible, and/or haptic signals. In some embodiments, the output device 1520 includes an electronically controllable display or display device capable of outputting visual data to a user. For example, the output device 1520 may include, but is not limited to, an LCD display, an LED display, an OLED display, a projector, or similar display device capable of outputting images, text, or the like to a user. As another, non-limiting, example, the output device 1520 may include a wearable display separate from, but communicatively coupled to, the rest of the network apparatus 1500, such as a smart watch, smart glasses, a heads-up display, or the like. Further, the output device 1520 may be a component of a smart phone, a personal digital assistant, a television, a table computer, a notebook (laptop) computer, a personal computer, a vehicle dashboard, or the like.

In certain embodiments, the output device 1520 includes one or more speakers for producing sound. For example, the output device 1520 may produce an audible alert or notification (e.g., a beep or chime). In some embodiments, the output device 1520 includes one or more haptic devices for producing vibrations, motion, or other haptic feedback. In some embodiments, all or portions of the output device 1520 may be integrated with the input device 1515. For example, the input device 1515 and output device 1520 may form a touchscreen or similar touch-sensitive display. In other embodiments, the output device 1520 may be located near the input device 1515.

The transceiver 1525 includes at least transmitter 1530 and at least one receiver 1535. One or more transmitters 1530 may be used to communicate with the UE, as described herein. Similarly, one or more receivers 1535 may be used to communicate with network functions in the NPN, PLMN and/or RAN, as described herein. Although only one transmitter 1530 and one receiver 1535 are illustrated, the network apparatus 1500 may have any suitable number of transmitters 1530 and receivers 1535. Further, the transmitter(s) 1530 and the receiver(s) 1535 may be any suitable type of transmitters and receivers.

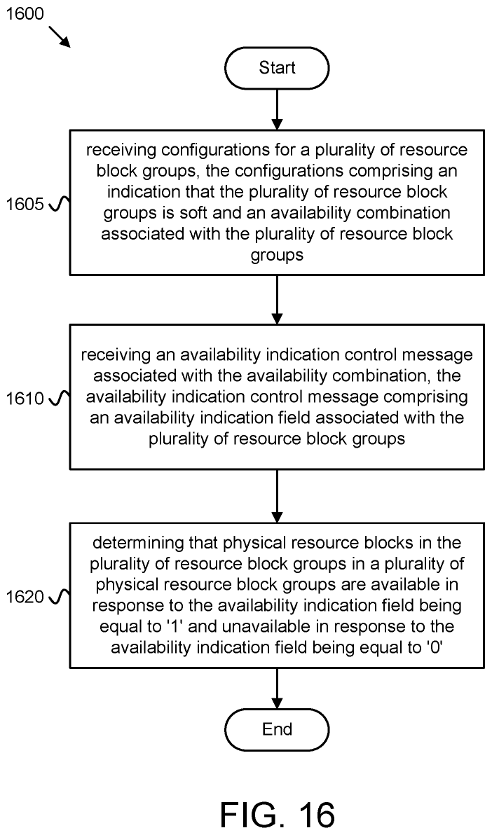

FIG. 16 is a flowchart diagram of a method 1600 for soft resource management in integrated access and backhaul may be used. The method 1600 may be performed by a UE as described herein, for example, the remote unit 105, the UE 205 and/or the user equipment apparatus 1400, and/or by a network device as described herein, for example, a gNB and/or network equipment apparatus 1500. In some embodiments, the method 1600 may be performed by a processor executing program code, for example, a microcontroller, a microprocessor, a CPU, a GPU, an auxiliary processing unit, a FPGA, or the like.

In one embodiment, the method 1600 includes receiving 1605 configurations for a plurality of resource block groups, the configurations comprising an indication that the plurality of resource block groups is soft and an availability combination associated with the plurality of resource block groups. In one embodiment, the method 1600 includes receiving 1610 an availability indication control message associated with the availability combination, the availability indication control message comprising an availability indication field associated with the plurality of resource block groups. The method 1600, in one embodiment, includes determining 1615 that physical resource blocks in the plurality of resource block groups in a plurality of physical resource block groups are available in response to the availability indication field being equal to ‘1’ and unavailable in response to the availability indication field being equal to ‘0’. The method 1600 ends.

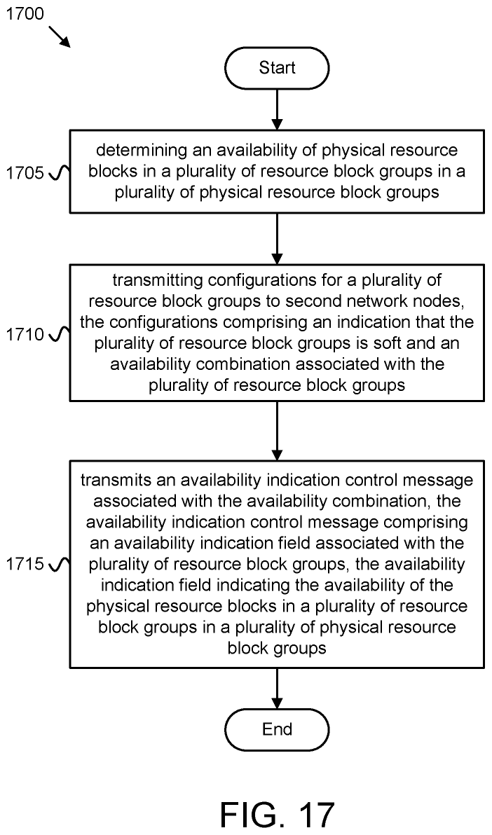

FIG. 17 is a flowchart diagram of a method 1700 for soft resource management in integrated access and backhaul may be used. The method 1700 may be performed by a UE as described herein, for example, the remote unit 105, the UE 205 and/or the user equipment apparatus 1400, and/or by a network device as described herein, for example, a gNB and/or network equipment apparatus 1500. In some embodiments, the method 1700 may be performed by a processor executing program code, for example, a microcontroller, a microprocessor, a CPU, a GPU, an auxiliary processing unit, a FPGA, or the like.

In one embodiment, the method 1700 includes determining 1705 an availability of physical resource blocks in a plurality of resource block groups in a plurality of physical resource block groups. In one embodiment, the method 1700 includes transmitting 1710 configurations for a plurality of resource block groups to second network nodes, the configurations comprising an indication that the plurality of resource block groups is soft and an availability combination associated with the plurality of resource block groups. In one embodiment, the method 1700 includes transmitting 1715 an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups. The method 1700 ends.

A first apparatus is disclosed for soft resource management in integrated access and backhaul may be used. The first apparatus may include a UE as described herein, for example, the remote unit 105, the UE 205 and/or the user equipment apparatus 1400, and/or by a network device as described herein, for example, a gNB and/or network equipment apparatus 1500. In some embodiments, the first apparatus includes a processor executing program code, for example, a microcontroller, a microprocessor, a CPU, a GPU, an auxiliary processing unit, a FPGA, or the like.

In one embodiment, the first apparatus includes a transceiver that receives configurations for a plurality of resource block groups, the configurations comprising an indication that the plurality of resource block groups is soft and an availability combination associated with the plurality of resource block groups. In one embodiment, the transceiver receives an availability indication control message associated with the availability combination, the availability indication control message comprising an availability indication field associated with the plurality of resource block groups. In one embodiment, the first apparatus includes a processor that determines that physical resource blocks in the plurality of resource block groups in a plurality of physical resource block groups are available in response to the availability indication field being equal to ‘1’ and unavailable in response to the availability indication field being equal to ‘0’.

In one embodiment, the transceiver receives configurations for a plurality of physical resource blocks in a frequency domain and configurations for the plurality of resource block groups, each resource block group comprising a first number of physical resource blocks.

In one embodiment, the availability indication field is a bit in a bitmap of the availability indication control message.

In one embodiment, the availability indication control message is a downlink control information message.

In one embodiment, the transceiver receives a first control message indicating that a first resource is conditionally available by a first entity, the first resource comprising a soft resource and the processor performs a downlink transmission by the first resource in response to determining that the downlink transmission does not change an uplink transmission on a second resource at a second entity, the second resource overlapping the first resource in a time domain and omits a downlink transmission on the first resource in response to determining that the downlink transmission changes an uplink transmission on the second resource at the second entity, the second resource overlapping the first resource in a time domain.

In one embodiment, the transceiver transmits a second control message to a second network node, the second network node comprising a serving node of the network node, the second control message indicating whether the downlink transmission was omitted.

In one embodiment, the transceiver transmits a message to a third network node, the third network node comprising a configuration entity, the message indicating whether the downlink transmission was omitted.

In one embodiment, the configuration entity is a central unit that transmits configurations to the UE device.

In one embodiment, the network node is an integrated access and backhaul node, the first entity is a distributed unit, and the second entity is a mobile terminal.

In one embodiment, the determining is based at least in part on one or more of a multiplexing capability of the network node, a duplexing capability of the network node, a capability of time-domain multiplexing between the first entity and the second entity, and a number of antenna panels of the network node.

In one embodiment, the determining is based at least in part on one or more of a beamforming constraint, a power imbalance constraint, a total power constraint, an interference constraint, and a timing alignment constraint.

In one embodiment, the transceiver transmits, over an F1 interface and an Xn interface, a configuration comprising information indicating a set of soft resource blocks and receives, over the F1 interface, at least one of the availability indication control message and at least one conditional availability indication message associated with at least one soft resource block in the set of soft resource blocks. In one embodiment, the processor computes an availability indication parameter as a function of at least one of the availability indication message and at least one conditional availability indication message. In one embodiment, the transceiver transmits, over the Xn interface, an information element comprising the availability indication parameter.

In one embodiment, the function is at least one of a field-wise average, a field-wise logical OR function, and a field-wise logical AND function of at least one of the availability indication message and the at least one conditional availability message.

In one embodiment, at least one of the availability indication message and the at least one conditional availability message is associated with at least one integrated access and backhaul node.

In one embodiment, the at least one integrated access and backhaul node receives the configuration over the F1 interface.

A first method is disclosed for soft resource management in integrated access and backhaul may be used. The first method may be performed by a UE as described herein, for example, the remote unit 105, the UE 205 and/or the user equipment apparatus 1400, and/or by a network device as described herein, for example, a gNB and/or network equipment apparatus 1500. In some embodiments, the first method may be performed by a processor executing program code, for example, a microcontroller, a microprocessor, a CPU, a GPU, an auxiliary processing unit, a FPGA, or the like.

In one embodiment, the first method includes receiving configurations for a plurality of resource block groups, the configurations comprising an indication that the plurality of resource block groups is soft and an availability combination associated with the plurality of resource block groups. In one embodiment, the first method includes receiving an availability indication control message associated with the availability combination, the availability indication control message comprising an availability indication field associated with the plurality of resource block groups. In one embodiment, the first method includes determining that physical resource blocks in the plurality of resource block groups in a plurality of physical resource block groups are available in response to the availability indication field being equal to ‘1’ and unavailable in response to the availability indication field being equal to ‘0’.

In one embodiment, the first method includes receiving configurations for a plurality of physical resource blocks in a frequency domain and configurations for the plurality of resource block groups, each resource block group comprising a first number of physical resource blocks.

In one embodiment, the availability indication field is a bit in a bitmap of the availability indication control message.

In one embodiment, the availability indication control message is a downlink control information message.

In one embodiment, the first method includes receiving a first control message indicating that a first resource is conditionally available by a first entity, the first resource comprising a soft resource, performing a downlink transmission by the first resource in response to determining that the downlink transmission does not change an uplink transmission on a second resource at a second entity, the second resource overlapping the first resource in a time domain, and omitting a downlink transmission on the first resource in response to determining that the downlink transmission changes an uplink transmission on the second resource at the second entity, the second resource overlapping the first resource in a time domain.

In one embodiment, the first method includes transmitting a second control message to a second network node, the second network node comprising a serving node of the network node, the second control message indicating whether the downlink transmission was omitted.

In one embodiment, the first method includes transmitting a message to a third network node, the third network node comprising a configuration entity, the message indicating whether the downlink transmission was omitted.

In one embodiment, the configuration entity is a central unit that transmits configurations to the UE device.

In one embodiment, the network node is an integrated access and backhaul node, the first entity is a distributed unit, and the second entity is a mobile terminal.

In one embodiment, the determining is based at least in part on one or more of a multiplexing capability of the network node, a duplexing capability of the network node, a capability of time-domain multiplexing between the first entity and the second entity, and a number of antenna panels of the network node.

In one embodiment, the determining is based at least in part on one or more of a beamforming constraint, a power imbalance constraint, a total power constraint, an interference constraint, and a timing alignment constraint.

In one embodiment, the first method includes transmitting, over an F1 interface and an Xn interface, a configuration comprising information indicating a set of soft resource blocks and receiving, over the F1 interface, at least one of the availability indication control message and at least one conditional availability indication message associated with at least one soft resource block in the set of soft resource blocks. In one embodiment, the first method includes computing an availability indication parameter as a function of at least one of the availability indication message and at least one conditional availability indication message. In one embodiment, the first method includes transmitting, over the Xn interface, an information element comprising the availability indication parameter.

In one embodiment, the function is at least one of a field-wise average, a field-wise logical OR function, and a field-wise logical AND function of at least one of the availability indication message and the at least one conditional availability message.

In one embodiment, at least one of the availability indication message and the at least one conditional availability message is associated with at least one integrated access and backhaul node.

In one embodiment, the at least one integrated access and backhaul node receives the configuration over the F1 interface.

A second apparatus is disclosed for soft resource management in integrated access and backhaul may be used. The second apparatus may include a UE as described herein, for example, the remote unit 105, the UE 205 and/or the user equipment apparatus 1400, and/or by a network device as described herein, for example, a gNB and/or network equipment apparatus 1500. In some embodiments, the second apparatus includes a processor executing program code, for example, a microcontroller, a microprocessor, a CPU, a GPU, an auxiliary processing unit, a FPGA, or the like.

In one embodiment, the second apparatus includes a processor that determines an availability of physical resource blocks in a plurality of resource block groups in a plurality of physical resource block groups. In one embodiment, the second apparatus includes a transceiver that transmits configurations for a plurality of resource block groups to second network nodes, the configurations comprising an indication that the plurality of resource block groups is soft and an availability combination associated with the plurality of resource block groups and transmits an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

A second method is disclosed for soft resource management in integrated access and backhaul may be used. The second method may be performed by a UE as described herein, for example, the remote unit 105, the UE 205 and/or the user equipment apparatus 1400, and/or by a network device as described herein, for example, a gNB and/or network equipment apparatus 1500. In some embodiments, the second method may be performed by a processor executing program code, for example, a microcontroller, a microprocessor, a CPU, a GPU, an auxiliary processing unit, a FPGA, or the like.

In one embodiment, the second method includes determining an availability of physical resource blocks in a plurality of resource block groups in a plurality of physical resource block groups. In one embodiment, the second method includes transmitting configurations for a plurality of resource block groups to second network nodes, the configurations comprising an indication that the plurality of resource block groups is soft and an availability combination associated with the plurality of resource block groups and transmitting an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a network node, the method comprising:
receiving configurations for a plurality of resource block groups, the configurations comprising an indication that the plurality of resource block groups is soft and an availability combination associated with the plurality of resource block groups;
receiving an availability indication control message associated with the availability combination, the availability indication control message comprising an availability indication field associated with the plurality of resource block groups; and
determining that physical resource blocks in the plurality of resource block groups in a plurality of physical resource block groups are available in response to the availability indication field being equal to ‘l’ and unavailable in response to the availability indication field being equal to ‘0’.

2. The method of claim 1, further comprising receiving:
configurations for a plurality of physical resource blocks in a frequency domain; and
configurations for the plurality of resource block groups, each resource block group comprising a first number of physical resource blocks.

3. The method of claim 1, wherein the availability indication field is a bit in a bitmap of the availability indication control message.

4. The method of claim 1, wherein the availability indication control message is a downlink control information message.

5. The method of claim 1, further comprising:
receiving a first control message indicating that a first resource is conditionally available by a first entity, the first resource comprising a soft resource;
performing a downlink transmission by the first resource in response to determining that the downlink transmission does not change an uplink transmission on a second resource at a second entity, the second resource overlapping the first resource in a time domain; and
omitting a downlink transmission on the first resource in response to determining that the downlink transmission changes an uplink transmission on the second resource at the second entity, the second resource overlapping the first resource in a time domain.

6. The method of claim 5, further comprising transmitting a second control message to a second network node, the second network node comprising a serving node of the network node, the second control message indicating whether the downlink transmission was omitted.

7. The method of claim 6, further comprising transmitting a message to a third network node, the third network node comprising a configuration entity, the message indicating whether the downlink transmission was omitted.

8. The method of claim 5, wherein the network node is an integrated access and backhaul node, the first entity is a distributed unit, and the second entity is a mobile terminal.

9. The method of claim 5, wherein the determining is based at least in part on one or more of a multiplexing capability of the network node, a duplexing capability of the network node, a capability of time-domain multiplexing between the first entity and the second entity, and a number of antenna panels of the network node.

10. The method of claim 1, wherein the determining is based at least in part on one or more of a beamforming constraint, a power imbalance constraint, a total power constraint, an interference constraint, and a timing alignment constraint.

11. The method of claim 1, further comprising;
transmitting, over an F1 interface and an Xn interface, a configuration comprising information indicating a set of soft resource blocks;
receiving, over the F1 interface, at least one of the availability indication control message and at least one conditional availability indication message associated with at least one soft resource block in the set of soft resource blocks;
computing an availability indication parameter as a function of at least one of the availability indication message and at least one conditional availability indication message; and
transmitting, over the Xn interface, an information element comprising the availability indication parameter.

12. The method of claim 11, wherein the function is at least one of a field-wise average, a field-wise logical OR function, and a field-wise logical AND function of at least one of the availability indication message and the at least one conditional availability message.

13. The method of claim 11, wherein at least one of the availability indication message and the at least one conditional availability message is associated with at least one integrated access and backhaul node, the at least one integrated access and backhaul node receiving the configuration over the F1 interface.

14. A network node apparatus, the apparatus comprising:
a transceiver that:
receives configurations for a plurality of resource block groups, the configurations comprising an indication that the plurality of resource block groups is soft and an availability combination associated with the plurality of resource block groups; and
receives an availability indication control message associated with the availability combination, the availability indication control message comprising an availability indication field associated with the plurality of resource block groups; and
a processor that determines that physical resource blocks in the plurality of resource block groups in a plurality of physical resource block groups are available in response to the availability indication field being equal to ‘1’ and unavailable in response to the availability indication field being equal to ‘0’.

15. A network node apparatus, the apparatus comprising:
a processor that determines an availability of physical resource blocks in a plurality of resource block groups in a plurality of physical resource block groups; and
a transceiver that:
transmits configurations for a plurality of resource block groups to second network nodes, the configurations comprising an indication that the plurality of resource block groups is soft and an availability combination associated with the plurality of resource block groups; and
transmits an availability indication control message associated with the availability combination, the availability indication control message comprising an availability indication field associated with the plurality of resource block groups, the availability indication field indicating the availability of the physical resource blocks in a plurality of resource block groups in a plurality of physical resource block groups.
